(19) United States
(12) Patent Application Publication
(10) Pub. No.: US 2013/0271714 A1
(43) Pub. Date: Oct. 17, 2013

(54) ELECTRO-OPTIC APPARATUS AND ELECTRONIC APPARATUS

(71) Applicant: SEIKO EPSON CORPORATION, Tokyo (JP)

(72) Inventor: Takenori Hirota, Suwa-shi (JP)

(73) Assignee: Seiko Epson Corporation, Tokyo (JP)

(21) Appl. No.: 13/858,490

(22) Filed: Apr. 8, 2013

(30) Foreign Application Priority Data
Apr. 12, 2012 (JP) 2012090843

(51) Int. Cl. G02F 1/1339

(52) U.S. Cl. CPC G02F 1/1339
USPC 349/139; 349/153

(57) ABSTRACT

Provided is an electro-optic apparatus including an organic sealant that seals a first substrate and a second substrate, an inorganic sealant that surrounds the organic sealant which seals the first substrate and the second substrate, and an electro-optic material that is enclosed within an area surrounded by the organic sealant.

### BACKGROUND

1. Technical Field

The present invention relates to an electro-optic apparatus and an electronic apparatus equipped with the electro-optic apparatus.

2. Related Art

A liquid crystal display apparatus, one example of an electro-optic apparatus is widely used as an optical modulation unit (a light valve) of a projection type display apparatus such as a projector. The liquid crystal display apparatus is configured to include a pair of glass substrates on which an alignment film is formed, an organic sealant such as epoxy resin that glues the pair of glass substrates together, liquid crystal as an electro-optic material, which is enclosed inside an area sectioned with the organic sealant, an alignment film that controls an alignment state of the liquid crystal, and others.

Because strong light is emitted in the liquid crystal display apparatus in use for the light valve, an inorganic alignment film is used, such as SiO₂ that is excellent in light resistance and heat resistance. Because the inorganic alignment film has high polarity, and easily absorbs moisture, when the moisture in the liquid crystal penetrates into the inorganic alignment film, the moisture adheres to the inorganic alignment film. As a result, nonconformity, such as irregularity, occurs on display. For this reason, it is necessary to suppress the penetration of moisture into the liquid crystal display apparatus equipped with the inorganic alignment film.

As a method of suppressing the penetration of moisture into the electro-optic apparatus, for example, the electro-optic apparatus as disclosed in JP-A-10-74583 has been proposed. The electro-optic apparatus, disclosed in JP-A-10-74583, is an organic EL display apparatus in which a pair of glass substrates is sealed with a low-melting-point glass, and organic EL as the electro-optic material is enclosed inside an area sectioned with low-melting-point glass. Because the low-melting-point glass is melted and solidified by local heating through the use of a laser beam, thermal damage to the organic EL is small. Additionally, because the low-melting-point glass has excellent moisture resistance, the penetration of moisture into the inside is suppressed and deterioration in the organic EL due to moisture is suppressed.

However, when the method disclosed in JP-A-10-74583 is applied to the liquid crystal display apparatus, there is a problem in that the liquid crystal deteriorates (thermal decomposition) in a process of melting and solidifying the low-melting-point glass (the local heating though the use of the laser beam).

Additionally, the liquid crystal display apparatus in which the low-melting-point glass is used as the sealant can be manufactured without causing the deterioration in the liquid crystal described above, by using a method in which after partly gluing the pair of glass substrates together by melting and solidifying the low-melting-point glass the local heating though the use of the laser beam and then injecting the liquid crystal through an opening portion (an insertion hole). However, this causes a problem in that the liquid crystal is contaminated by the low-melting-point glass and display irregularity occurs.

### SUMMARY

The invention can be realized in the following forms or application examples.

According to an application example, there is provided an electro-optic apparatus including a first substrate, a second substrate that is arranged opposite to the first substrate, an organic sealant that glues the first substrate and the second substrate together and a main component of which is an organic material, an electro-optic material that is enclosed within an area surrounded by the organic sealant, and an inorganic sealant that glues the first substrate and the second substrate together, and that is formed between an edge of the first substrate and the organic sealant, in the shape of a frame, surrounding the organic sealant.

The inorganic sealant has excellent moisture resistance. For this reason, penetration of external moisture (water) into the electro-optic material is suppressed by enclosing the electro-optic material within the area (an airtight area) surrounded by the inorganic sealant. Therefore, the liquid crystal apparatus is provided in which a change (deterioration) in display performance due to external moisture is suppressed and thus the humidity resistance is excellent.

Additionally, because the organic sealant is interposed between the inorganic sealant and the electro-optic material and the inorganic sealant and the electro-optic material are separated from each other, the inorganic sealant prevents the electro-optic material from being contaminated. Additionally, the deterioration in the electro-optic material (thermal decomposition) is suppressed during a process of forming the inorganic sealant (local heating by a laser beam). Therefore, bad influences on the electro-optic material (the thermal decomposition, contamination, and the like) are suppressed by forming the inorganic sealant, and thus the electro-optic apparatus is provided that is excellent in display quality.

According to an application example, there is provided an electro-optic apparatus including a first substrate, a second substrate that is arranged opposite to the first substrate, and an edge of which protrudes much more than an edge of the first substrate, an organic sealant that glues the first substrate and the second substrate together and a main component of which is an organic material, an electro-optic material that is enclosed within an area surrounded by the organic sealant, a third substrate that is arranged in such a manner that the first substrate is interposed between and is supported by the third substrate and the second substrate, and an edge of which protrudes much more than an edge of the first substrate, and an inorganic sealant that glues the second substrate and the third substrate together, and that is formed between the edge of the first substrate and an edge of the second substrate, in the shape of a frame, surrounding the organic sealant.

The electro-optic material, which is enclosed by the first substrate, the second substrate, and the organic sealant, is further enclosed by the second substrate, the third substrate, and the inorganic sealant, resulting in being enclosed twofold. Because the second substrate, the third substrate, and the inorganic sealant have excellent moisture resistance, the penetration of external moisture (water) into the area enclosed twofold is suppressed. That is, the electro-optical apparatus with excellent moisture resistance is provided in which the penetration of water into the electro-optic material is suppressed, and thus the change (the deterioration) in the display performance due to the external moisture is suppressed.

Additionally, because the organic sealant is interposed between the inorganic sealant and the electro-optic material, and the inorganic sealant and the electro-optic material are separated from each other, the inorganic sealant prevents the electro-optic material from being contaminated. Additionally, the deterioration in the electro-optic material (the thermal decomposition) is suppressed during the process of forming the inorganic sealant (the local heating by the laser beam). Therefore, the bad influence on the electro-optic material (the thermal decomposition, the contamination, and the like) is suppressed by forming the inorganic sealant, and thus the electro-optic apparatus is provided that is excellent in display quality.

According to still another application example, there is provided an electro-optic apparatus including a first substrate, a second substrate that is arranged opposite to the first substrate, and that has a protrusion portion which protrudes much more than an edge of the first substrate when viewed from above and on which a plurality of terminals are formed, an organic sealant that glues the first substrate and the second substrate together and a main component of which is an organic material, an electro-optic material that is enclosed within an area surrounded by the organic sealant, a third substrate that is arranged in such a manner that the first substrate is interposed between and is supported by the third substrate and the second substrate, and an edge of which protrudes much than an edge of the first substrate when viewed from above, and a fourth substrate that is arranged in such a manner that the second substrate is interposed between and is supported by the fourth substrate and the first substrate, and an edge of which protrudes much more than the edge of the first substrate when viewed from above, and an inorganic sealant that is formed in the shape of a frame in such a manner as to surround the organic sealant when viewed from above, in which the edge of the third substrate is formed between the edge of the first substrate and the plurality of terminals in the protrusion portion of the second substrate. and the edges of the third substrate and the fourth substrate protrude much more than the edge of the second substrate in areas other than the protrusion portions of the second substrate, and in which the inorganic sealant that glues a portion of the third substrate, which overlaps the protrusion portion of the second substrate, when viewed from above, and the protrusion portion of the second substrate together, and glues the third substrate and the fourth substrate together, between the edge of the third substrate and the edge of the second substrate, in the areas other than the protrusion portion of the second substrate.

The electro-optic material, which is enclosed by the first substrate, the second substrate, and the organic sealant, is further enclosed by the second substrate, the third substrate, the fourth substrate and the inorganic sealant, resulting in being enclosed twofold. Because the second substrate, the third substrate, the fourth substrate and the inorganic sealant have excellent moisture resistance, the penetration of external moisture (water) into the area enclosed twofold is suppressed. That is, the electro-optic apparatus with excellent moisture resistance is provided in which the penetration of water into the electro-optic material is suppressed, and thus the change (the deterioration) in the display performance due to the external moisture is suppressed.

Additionally, because the organic sealant is interposed between the inorganic sealant and the electro-optic material, and the inorganic sealant and the electro-optic material are separated from each other, the inorganic sealant prevents the electro-optic material from being contaminated. Additionally, the deterioration in the electro-optic material (the thermal decomposition) is suppressed during the process of forming the inorganic sealant (the local heating by the laser beam). Therefore, the bad influence on the electro-optic material (the thermal decomposition, the contamination, and the like) is suppressed by forming the inorganic sealant, and thus the electro-optic apparatus is provided that is excellent in display quality.

In the electro-optic apparatus according to the application examples, the second substrate may include a metal film, in which the inorganic sealant on the second substrate may be locally heated by a laser beam that is incident on the second substrate from the first substrate, and in which a protective film may be formed between the metal film and the inorganic sealant, on the second substrate, to mitigate an influence of the local heating on the metal film.

The thermal damage to the organic sealant and the electro-optic material that are arranged in the vicinity of the inorganic sealant can be suppressed and the inorganic sealant can be formed, through the use of the local heating by the laser beam. Additionally, because the protective film makes it difficult for the heat of the inorganic sealant locally heated by the laser beam to be transferred to the metal film, nonconformity is suppressed that is called a crack in the insulating film covering a hillock of the metal film and the metal film.

In the electro-optic apparatus according to the application examples, a material with which the protective film is formed is preferably any one of silicon oxide, silicon nitride and silicon oxynitride.

Because the protective film, made from any one of silicon oxide, silicon nitride and silicon oxynitride, is formed between the metal film and the inorganic sealant, the heat of the inorganic sealant locally heated by the laser beam is not conducted to the metal film. Additionally, because silicon oxide, silicon nitride and silicon oxynitride have a dense film structure, the penetration of water into the inside is suppressed.

In the electro-optic apparatus according to the application examples, a material with which the inorganic sealant is formed is preferably any one of a metal and a low-melting-point glass that is lower in melting point than the first substrate.

Because the metal and the low-melting-point glass have excellent moisture resistance, the penetration of water into the electro-optic material is suppressed by the enclosing with the metal, or the low-melting-point glass.

In the electro-optic apparatus according to the application examples, a concavity portion is preferably formed on the third substrate, and the first substrate may fit into the concavity portion.

An interval between the third substrate and the second substrate can be decreased by fitting the first substrate into the concavity portion formed in the third substrate. As a result, a length (a thickness) of the inorganic sealant formed between the third substrate and the second substrate can be decreased and the laser beam emitting time to form the inorganic sealant can be shortened. Additionally, the distortions of the inorganic sealant that occur due to melting by the laser beam and the solidification are also reduced, and cracks in the inorganic sealant and the like are suppressed.

In the electro-optic apparatus according to the application examples, the concavity portion is preferably formed on at least one of the third substrate and the fourth substrate, and at least one of the first substrate and the second substrate may fit into the concavity portion.

An interval between the third substrate and the fourth substrate can be decreased by fitting at least one of the first substrate and the second substrate into the concavity portion formed in at least one of the third substrate and the fourth substrate. As a result, the length (the thickness) of the inorganic sealant formed between the third substrate and the fourth substrate can be decreased and the laser beam emitting time to form the inorganic sealant can be shortened. Additionally, the distortions of the inorganic sealant that occur due to the melting by the laser beam and the solidification are also reduced, and the cracks in the inorganic sealant and the like are suppressed.

In the electro-optic apparatus according to the application examples, a transparent opposite electrode is preferably formed on the first substrate, a reflection electrode is preferably formed on the second substrate, and the reflection electrode is preferably covered with a dielectric film that extends to an area on which the inorganic sealant is formed.

Because the dielectric film that covers the reflection electrode extends to the area on which the inorganic sealant is formed and the dielectric film is present under the inorganic sealant, the conduction of the heat of the inorganic sealant locally heated by the laser beam is suppressed by the dielectric film. That is, the heat of the inorganic sealant is difficult to conduct below the dielectric film.

In the electro-optic apparatus according to the application examples, a material with which the dielectric film is formed is preferably any one of silicon oxide, silicon nitride, silicon oxynitride and aluminum oxide.

The formation of the dielectric film, configured from any one of silicon oxide, silicon nitride, silicon oxynitride and aluminum oxide, between the metal film and the inorganic sealant makes it difficult for the heat of the inorganic sealant locally heated by the laser beam to be conducted to the metal film. Additionally, because silicon oxide, silicon nitride, silicon oxynitride and aluminum oxide have a dense film structure, the penetration of water into the inside is suppressed.

The electro-optic apparatus according to the application example preferably further includes an inorganic alignment layer that is oblique-deposited.

Because the influence of external moisture (water) is suppressed due to the inorganic sealant in the corresponding electro-optic apparatus, even though the inorganic alignment film, which is weak in moisture resistance, is used, the external moisture does not cause the change (the deterioration) in display performance. Additionally, the electro-optic apparatus with high reliability, in which the display quality due to light and temperature is difficult to change (deteriorate), is provided by using the inorganic orientation film, excellent in moisture resistance and heat resistance.

According to still another application example, there is provided an electronic apparatus including the electro-optic apparatus according to the application examples.

Because the electronic apparatus is equipped with the electro-optic apparatus according to application examples, the electronic apparatus has the display quality that is difficult to deteriorate due to external moisture, light, and heat, and the display quality that is excellent in moisture resistance, light resistance, and heat resistance. For example, various electronic apparatus can be realized that includes a projector, a rear projection type television, a direct view type television, a mobile phone, a portable audio apparatus, a personal computer, a monitor of a video camera, a car navigation apparatus, a pager, a personal digital assistance, an electronic calculator, a word processor, a workstation, a videophone, a POS terminal, the digital still camera and others.

### BRIEF DESCRIPTION OF THE DRAWINGS

The invention will be described with reference to the accompanying drawings, wherein like numbers reference like elements.

FIGS. 1A and 1B are schematic diagrams, each illustrating a configuration of a display apparatus according to a first embodiment.

FIGS. 2A and 2B are schematic diagrams, each illustrating a configuration of an element substrate according to the first embodiment.

FIGS. 3A and 3B are schematic diagrams, each illustrating a configuration of an opposite substrate according to the first embodiment.

FIG. 4 is a flowchart that illustrates a process of manufacturing the display apparatus according to the first embodiment, in process step order.

FIGS. 5A and 5B are schematic diagrams, each illustrating a configuration of a display apparatus according to a second embodiment.

FIGS. 6A and 6B are schematic diagrams, each illustrating a configuration of an element substrate according to the second embodiment.

FIGS. 7A and 7B are schematic diagrams, each illustrating a configuration of an opposite substrate according to the second embodiment.

FIG. 8 is a flowchart that illustrates a process of manufacturing the display apparatus according to the second embodiment, in process step order.

FIGS. 9A and 9B are schematic diagrams, each illustrating a configuration of a display apparatus according to a third embodiment.

FIGS. 10A and 10B are schematic diagrams, each illustrating a configuration of an element substrate according to the third embodiment.

FIGS. 11A and 11B are schematic diagrams, each illustrating a configuration of an opposite substrate according to the third embodiment.

FIG. 12 is a flowchart that illustrates a process of manufacturing the display apparatus according to the third embodiment, in process step order.

FIGS. 13A and 13B are schematic diagrams, each illustrating a configuration of a display apparatus according to Modification Example 1.

FIG. 14 is a perspective view illustrating a protective substrate according to Modification Example 1.

FIGS. 15A and 15B are schematic diagrams, each illustrating a configuration of a display apparatus according to Modification Example 2.

FIGS. 16A and 16B are perspective views, each illustrating a first protective substrate and a second protective substrate according to Modification Example 2.

FIGS. 17A to 17C are schematic diagrams, each illustrating the configuration of the display apparatus according to Modification Example 2.

FIG. 18 is a schematic diagram illustrating a configuration of a projector as the electronic apparatus.

### DESCRIPTION OF EXEMPLARY EMBODIMENTS

Embodiments according to the invention are described below referring to the drawings. Each of the embodiments illustrates one aspect of the invention and can be arbitrarily modified within the technological idea behind the invention without limiting the invention. Furthermore, because, in the following drawings, each layer and each part are enlarged in size to the extent that they are recognizable in the drawings, reduced scales of each layer and each part are different from the real-world layer and part.

### First Embodiment

Outline of Display Apparatus

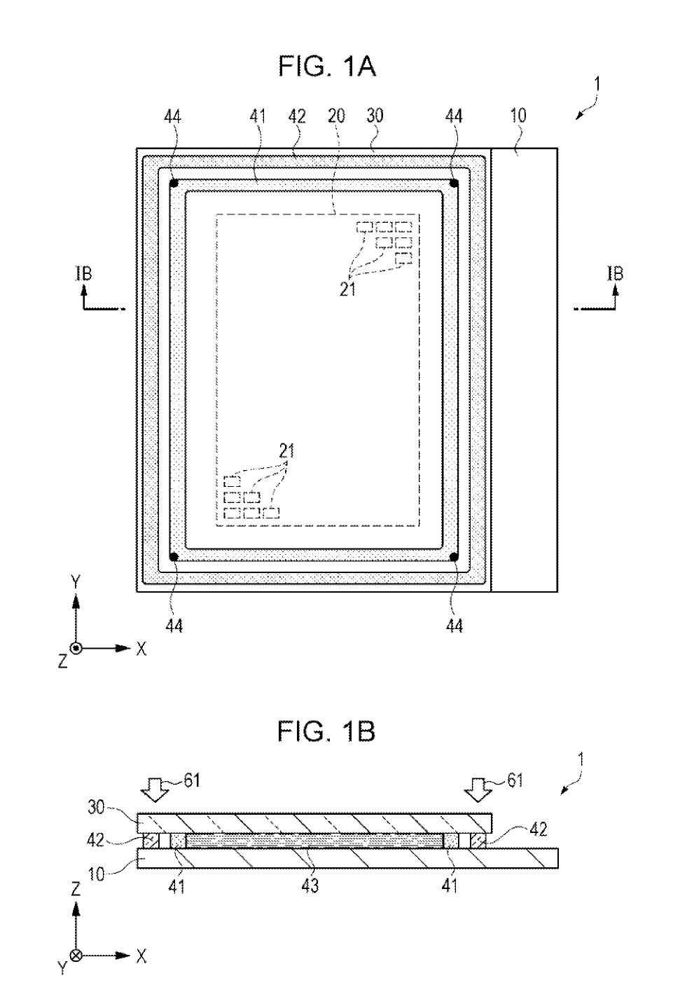

FIGS. 1A and 1B are diagrams, each illustrating a configuration of a display apparatus according to a first embodiment. FIG. 1A is a schematic plan view. FIG. 1B is a schematic cross-sectional view of FIG. 1A that is taken along a line IB-IB. First, an outline of the display apparatus as an electro-optic apparatus according to the first embodiment is described referring to FIGS. 1A and 1B. In addition, an arrow in FIG. 1B indicates an incident direction of a laser beam.

A display apparatus 1 is a liquid crystal display apparatus which is sealed twofold by an organic sealant 41 and an inorganic sealant 42, and in which penetration of moisture into the inside is suppressed. The display apparatus 1 is configured to include an opposite substrate 30, an element substrate 10, the organic sealant 41 that is interposed between and supported by the element substrate 10 and opposite substrate 30, the inorganic sealant 42, liquid crystal 43, a conduction material 44 and others.

The opposite substrate 30 is one example of a “first substrate”, and is a substrate that supplies a voltage to drive the liquid crystal 43.

The element substrate 10 is one example of a “second substrate”, and is another substrate that supplies the voltage to drive the liquid crystal 43. The element substrate 10 is arranged opposite to the opposite substrate 30, and one side thereof projects from the opposite substrate 30, when viewed from above. Furthermore, a lengthwise rectangular display area 20, in which pixels 21 are arranged in a matrix form, is formed on the element substrate 10.

The organic sealant 41 is one example of an “organic sealant, a main component of which is an organic material”. The organic sealant 41 is formed in the shape of a frame, surrounding the display area 20 and glues the opposite substrate 30 and the element substrate 10 together. In the organic sealant 41, a filler (an illustration thereof is omitted) is dispersed to form a predetermined gap between the opposite substrate 30 and the element substrate 10.

The inorganic sealant 42 is a low-melting-point glass that is melted by a local heating of a laser beam 61 and is solidified, and glues the opposite substrate 30 and the element substrate 10 together. The inorganic sealant 42 is formed in the shape of a frame form, surrounding the organic sealant 41, between the edge (an end surface) of the opposite substrate 30 and the organic sealant 41.

The liquid crystal 43 is one example of an “electro-optic material”. The liquid crystal 43 is enclosed inside an area (a sealed area), surrounded by the organic sealant 41 between the opposite substrate 30 and the element substrate 10. An orientation state of the liquid crystal 43 varies with a voltage applied between the opposite substrate 30 and the element substrate 10 (the pixels 21), and light in the display area 20 is modulated. For the liquid crystal 43, liquid crystal that is negative in dielectric anisotropy is used as a suitable example.

The conduction material 44 is an anisotropic conductive material to make a conduction between the element substrate 10 and the opposite substrate 30. The conduction material 44 is formed in four places close to a corner portion of the frame-shaped organic sealant 41, between the organic sealant 41 and the inorganic sealant 42.

In addition, in each drawing that includes FIGS. 1A and 1B, a traverse direction (a short-side direction) is defined as an X-axis direction, and a longitudinal direction (a long-side direction) intersecting the X-axis direction is defined as a Y-axis direction, in the display area 20 in the lengthwise rectangular form. Additionally, a thickness direction of the display apparatus 1 that intersects the X-axis and the Y-axis is defined as a Z-axis direction.

### Outline of Element Substrate

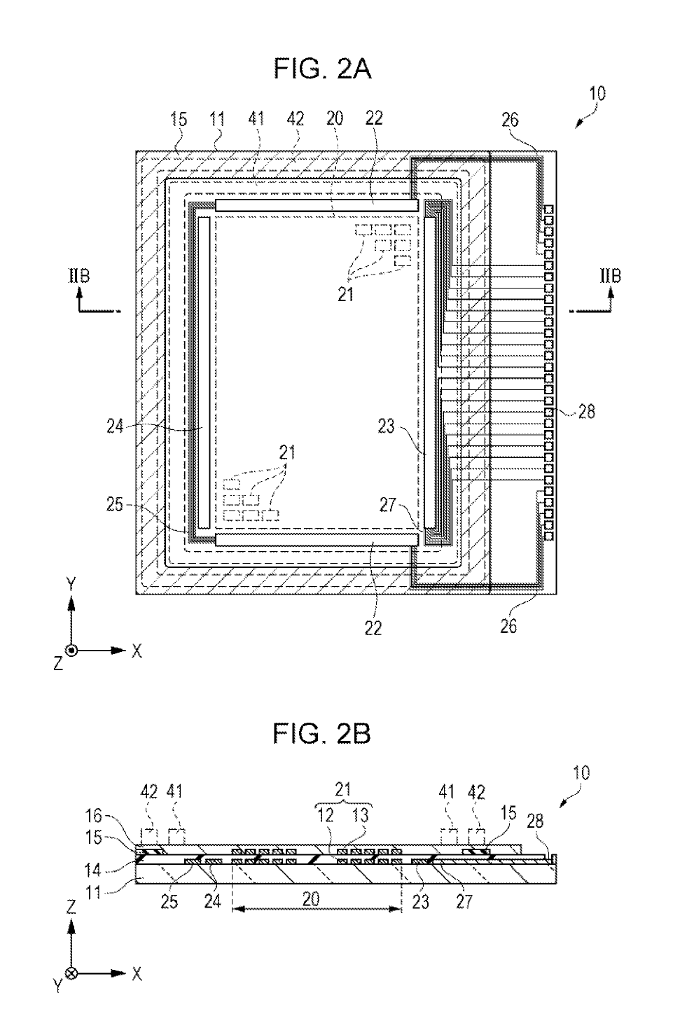

FIGS. 2A and 2B are diagrams, each illustrating a configuration of the element substrate. FIG. 2A is a schematic plan view. FIG. 2B is a schematic cross-sectional view of FIG. 2A that is taken along a line IIB-IIB. In addition, the organic sealant and the inorganic sealant are indicated by broken lines in FIGS. 2A and 2B. An outline of the element substrate according to the first embodiment is described below, referring to FIGS. 2A and 2B.

The element substrate 10 is configured to include a main body 11 of an element substrate, pixels 21, a circuit portion, a wiring portion, a terminal 28, a protective film 15, an alignment film 16, and others.

A quartz glass is used, as a suitable example, in the main body 11 of the element substrate. For main body 11 of element substrate, non-alkaline glass, a silicon substrate, may be used in addition to quartz glass.

The pixels 21 are arranged in the shape of a matrix in the X-axis direction and in the Y-axis direction, as described above, and a signal that controls the orientation state of the liquid crystal 43 is supplied from the circuit portion to the pixels 21. The pixel 21 is configured to include a thin-film transistor (hereinafter referred to as a TFT) 12, a pixel electrode 13 and others. The TFT 12 is a n-channel type transistor, and it is made from a multi-layer construction (an illustration thereof is omitted) that is configured to include a metal film, a semiconductor film, an insulating film and others. The pixel electrode 13 is a transparent electrode that is made from indium tin oxide (hereinafter referred to as an ITO). The TFT 12 and the pixel electrode 13 are electrically connected to each other through an inter-layer insulating film 14.

The circuit portion is a circuit that is configured from a complementary type transistor that includes a re-channel type transistor and a P-channel type transistor, and is formed in the process as TFT 12. The circuit portion is formed between the display area 20 and the organic sealant 41, and have a scan line drive circuit 22, a signal line drive circuit 23, an inspection circuit 24 and others. In addition, according to a configuration of the circuit portion, there is a case where the circuit portion is formed between the organic sealant 41 and the inorganic sealant 42.

The scan line drive circuit 22 is adjacent to the display area 20, and is formed in two places on the Y-axis (−) direction side and on the Y-axis (+) direction side. A scan signal that turns TFT 12 on and off is supplied from the scan line drive circuit 22.

The signal line drive circuit 23 is adjacent to the display area 20, and is formed on the X-axis (+) direction side. At a timing when TFT 12 turn on, a display signal that is to be supplied from the signal line drive circuit 23 to a signal line is supplied to the pixel electrode 13, and is maintained for a predetermined period of time.

The inspection circuit 24 is adjacent to the display area 20, and is formed on the X-axis (−) direction side. An operational state of the signal line drive circuit 23 and others are inspected by the inspection circuit 24.

The wiring portion is formed in the same process as TFT 12, and is made from the multi-layer construction that is configured from the metal film and the insulating film. The wiring portion is configured to include wiring 25 that connects between the scan line drive circuits 22 arranged between the both ends of display area 20, wiring 26 that connects between the scan line drive circuits 22 and the terminal 28, wiring 27 that connects between the signal line drive circuit 23 and the terminal 28, wiring (an illustration thereof is omitted) that connects between the inspection circuit 24 and the terminal 28, wiring (an illustration thereof is omitted) that connects between the pixel 21 and the circuit portion and others.

The terminal 28 is an electrode terminal for a connection with a flexible substrate (an illustration thereof is omitted) and is formed in an area that projects in the X-axis (+) direction of the element substrate 10. The terminal 28 is configured from a metal film that is formed in the same process as TFT 12. An opening area in the inter-layer insulating film 14 that covers the metal film that extends from the wiring portion is a terminal 28. A signal that drives the circuit portion is supplied from the flexible substrate to the circuit portion through the terminal 28.

The protective film 15 is an insulating film that is formed between the inter-layer insulating film 14 and the alignment film 16, and is formed in the shape of a frame on an edge portion of the element substrate 10. For the protective film 15, silicon oxide (SiO₂) is used as a suitable example. In addition to silicon oxide, silicon nitride, silicon oxynitride and others can be used as the protective film 15.

The protective film 15 is formed below (Z-axis (−) direction) the inorganic sealant 42, and when viewed from above, is greater in width than the inorganic sealant 42 and covers the inorganic sealant 42. In other words, the protective film 15, greater than the inorganic sealant 42, is formed in the area to which the laser beam 61 is emitted. Then, the wiring portion (the metal film and that insulating film that makes up the wiring portion), the inter-layer insulating film 14, the protective film 15, the alignment film 16, the inorganic sealant 42 and others are deposited in this sequence on the element substrate 11 in the area to which the laser beam 61 is emitted.

In this manner, the protective film 15, which is lower in thermal conductivity than the metal film, is interposed between at least the inorganic sealant 42 and the metal film (the wiring 26 and the wiring 27) of the wiring portion, and this makes it difficult for heat of the inorganic sealant 42 locally heated by the laser beam 61 to be conducted to the metal film of the wiring portion formed below. Because the protective film 15 decreases a rise in temperature of the metal film due to the local heating by the laser beam 61, the nonconformance is suppressed that is called a crack in the insulating film covering a hillock of the metal film and the metal film.

In addition to the metal film of the wiring portion described above, the metal films, such as an alignment mark (an illustration thereof is omitted) and a test pattern (an illustration thereof is omitted), are formed in the area to which the laser beam 61 is emitted. Because the protective film 15 is interposed between the corresponding metal film and the inorganic sealant 42, the nonconformance is suppressed that is called the crack in the insulating film covering the hillock of the metal film and the metal film on areas other than the wiring portion.

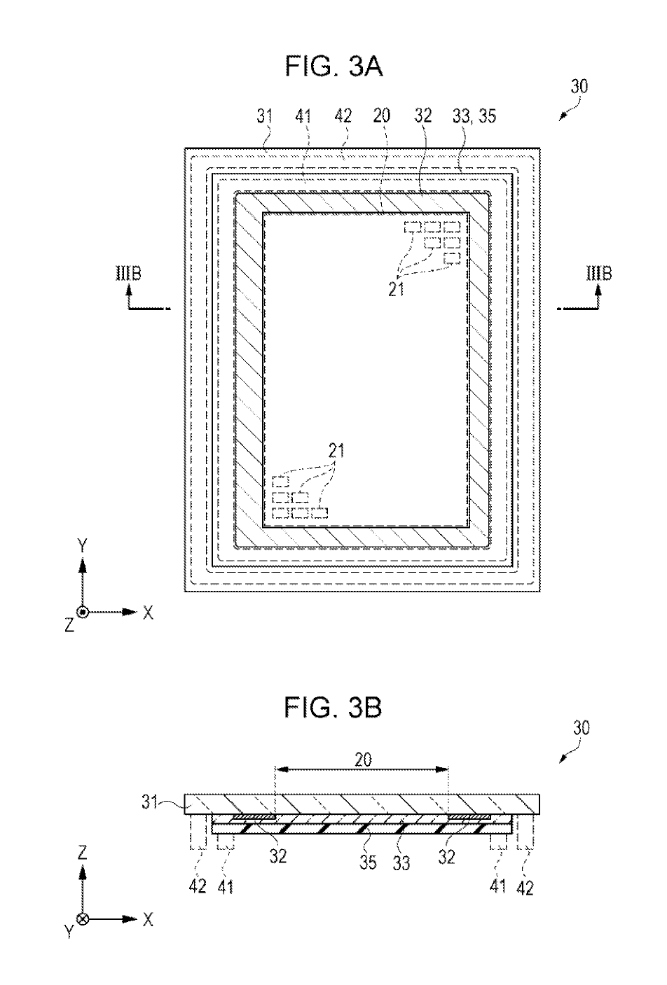

The alignment film 16 is an inorganic alignment film that is oblique-deposited, and for the alignment film 16, silicon oxide is used as a suitable example. The inorganic alignment film is excellent in heat resistance and light resistance, and is suitable for the display apparatus in use for of a project in which strong light is emitted. For the alignment film 16, in addition to silicon oxide, aluminum oxide (Al₂O₃), magnesium fluoride (MgF₂) and others can be used. The alignment film 16 on the opposite substrate 30 (refer to FIGS. 3A and 3B) described below is also an inorganic alignment film (silicon oxide) that is oblique-deposited. On the surfaces of the alignment films 16 and 35, in a case where a voltage is not applied, the liquid crystal 43 is oriented in the substantially perpendicular direction, and display in the normalblack mode, which is an indication of black display, is provided at the non-drive time.

### Outline of Opposite Substrate

FIGS. 3A and 3B are diagrams illustrating a configuration of the opposite substrates. FIG. 3A is a schematic plan view. FIG. 3B is a schematic cross-sectional view of FIG. 3A that is taken along a line IIIB-IIIB. In addition, the organic sealant and the inorganic sealant are indicated by broken lines in FIGS. 3A and 3B. An outline of the opposite substrate according to the first embodiment is described below, referring to FIGS. 3A and 3B.

The opposite substrate 30 is configured with a main body 31 of an opposite substrate, a light blocking film 32, a common electrode 33, an alignment film 35 and others.

For the main body 31 of the opposite substrate, a quartz glass is used as a suitable example. The opposite substrate 30 may be a transparent insulating substrate. For the opposite substrate 30, in addition to the quartz glass, a non-alkaline glass, a soda-lime glass coated with silicon oxide, and others can be used.

For the light blocking film 32, Cr is used as a suitable example, and the light blocking film 32 is formed in the shape of a frame between the display area 20 and the organic sealant 41. The light blocking film 32 has a role of giving up defining the display area 20 and a role of blocking light with respect to the circuit portion. Additionally, although the illustration is omitted, the light blocking film 32 is formed in the shape of an island in the display area 20. The light blocking film 32 formed in the display area 20 has a role of blocking light with respect to TFT 12.

The common electrode 33 is a transparent electrode that is made from ITO, and is formed between the light blocking film 32 and the alignment film 35. When viewed from above, the common electrode 33 is smaller than the main body 31 of the opposite substrate, and is formed within an area where the inorganic sealant 42 is formed. Common electric potential to drive the liquid crystal 43 is supplied from the circuit portion to the common electrode 33.

As described above, the alignment film 35 is an inorganic alignment film that is oblique-deposited, and for the alignment film 35, silicon oxide is used as a suitable example. When viewed from above, the alignment film 35 is smaller than the main body 31 of the opposite substrate, and is formed within an area where the inorganic sealant 42 is formed.

The laser beam 61 passes through the edge portion of the opposite substrate 30, and is locally emitted to an area on which the inorganic sealant 42 of the element substrate 10 is formed (refer to FIG. 1B). Since the common electrode 33 and the alignment film 35 are formed within the area where the inorganic sealant 42 is formed, the common electrode 33 and the alignment film 35 have not influenced the laser beam 61. That is, since the common electrode 33 and the alignment film 35 are not formed on the edge portion of the opposite substrate 30, attenuation of the laser beam 61 due to absorption or reflection is suppressed.

### Outline of Process of Manufacturing Display Apparatus

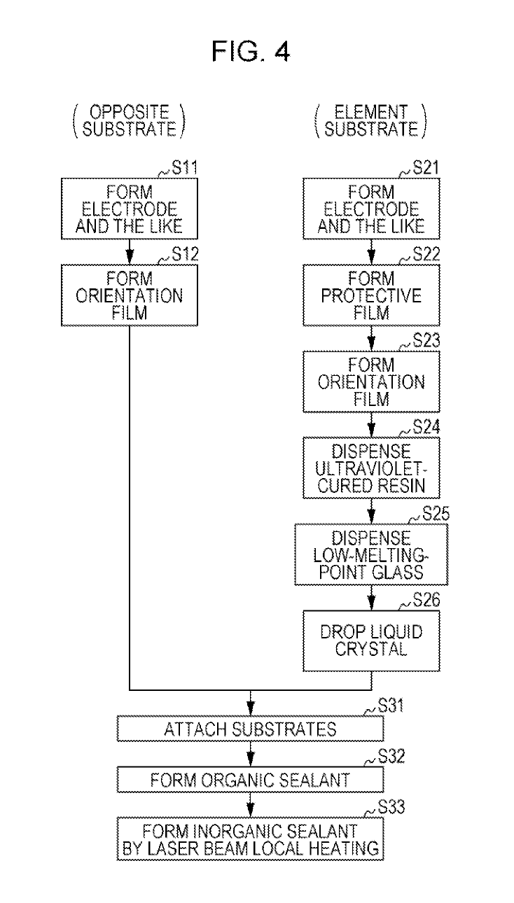

FIG. 4 is a flowchart that illustrates a process of manufacturing the display apparatus according to the first embodiment, in process step order. An outline of the process of manufacture of the display apparatus according to the first embodiment describe below, referring to FIG. 4.

In Step S11 of the process, electrodes and others are formed on the opposite substrate 30. Specifically, the blocking film 32, the common electrode 33 and others are formed on the main body 31 of the opposite substrate.

In Step S21 of the process, an electrode and others are formed on the element substrate 10. Specifically, TFT 12, the pixel electrode 13, the inter-layer insulating film 14, the circuit portion, the wiring portion and others are formed on the main body 11 of the element substrate.

In Step S22 of the process, the protective film 15 is formed in the shape of a frame on the edge portion of the main body 11 of the element substrate. Specifically, silicon oxide is deposited using the well-known P-CVD technology and is processed into a shape of a frame using the well-known photo etching technology.

In Steps S12 and S23 of the process, silicon oxide is oblique-deposited on the opposite substrate 30 and the element substrate 10 to form the alignment films 16 and 35.

In Step S24 of the process, ultraviolet-cured resin is dispensed onto the element substrate 10 in the shape of a frame, using a dispenser. For the ultraviolet-cured resin, an ultraviolet-cured type resin a main component of which is epoxy resin is used as a suitable example. In addition to the ultraviolet-cured resin, a heat-cured type resin, and a resin that is an ultraviolet-cured type, as well as a heat-cured type may be used.

In addition, the ultraviolet-cured resin is solidified in Step S32 of the process described below, and becomes the organic sealant 41.

By Step S25 of the process, the low-melting-point glass paste is dispensed onto the element substrate 10 using the dispenser to form a frame-shaped low-melting-point glass precursor in the vicinity of the ultraviolet-cured resin. In addition, the low-melting-point glass precursor is melted and solidified in Step S33 of the process described below and becomes the inorganic sealant 42.

In Step S26 of the process, the liquid crystal 43 is dropped onto within an area that is surrounded by the ultraviolet-cured resin. For a method of dropping the liquid crystal, the dispenser or an ink jet head can be used. The liquid crystal 43 is liquid crystal that is negative in dielectric anisotropy, as described above. The liquid crystal 43 is negative liquid crystal in a vertically aligned mode in which, in a case where voltage is not applied, liquid crystalline molecules are aligned in a substantially vertical direction. As long as the liquid crystal is the negative liquid crystal, one type of liquid crystal may be allowed, and multiple types of liquid crystal also may be mixed. Furthermore, for the liquid crystal 43, in addition to the negative liquid crystal, positive liquid crystal may be used that is made from liquid crystal that is positive in dielectric anisotropy.

In Step S31 of the process, the opposite substrate 30 and the element substrate 10 are attached to each other. Because when an amount of liquid crystal 43 dropped onto within the area, surrounded by the ultraviolet-cured resin, is excessive, the superfluous liquid crystal 43 flows over the area surrounded by the ultraviolet-cured resin at the time of attaching, it is necessary to make an amount of dropped liquid crystal 43 adequate in Step S26 of the process described above.

In Step S32 of the process, the ultraviolet ray is emitted and thus the ultraviolet-cured resin is solidified to form the organic sealant 41. In addition, moisture permeability of the organic sealant 41 is approximately 5 g/m²·24 h.

In Step S33 of the process, the laser beam 61 is locally emitted to the low-melting-point glass precursor to form the inorganic sealant 42. The inorganic sealant 42 is a low-melting-point glass that is lower in melting point than the main body 31 of the opposite substrate. For the inorganic sealant 42, a low-melting-point glass can be used that contains magnesium oxide (MgO), calcium oxide (CaO), barium oxide (BaO), lithium oxide (Li₂O), sodium oxide (Na₂O), potassium oxide (K₂O), boron oxide (B₂O₃), vanadium oxide (V₂O₅), zinc oxide (ZnO), oxidation tellurium (TeO₂), aluminum oxide (Al₂O₃), silicon oxide (SiO₂), plumbic oxide (PbO), tin oxide (SnO), oxidation phosphorus (P₂O₅), oxidation ruthenium (Ru₂O), oxidation rhodium (Rh₂O), iron oxide (Fe₂O₃), copper oxide (CuO), titanium oxide (TiO₂). tungsten oxide (WO₃), bismuth oxide (Bi₂O₃), antimony oxide (Sb₂O₃) or others. For example, a vanadium system low-melting-point glass, a lead system low-melting-point glass, a phosphate system low-melting-point glass, a bismuthate system low-melting-point glass, a borosilicate system low-melting-point glass and others can be used.

Because the moisture permeability of the inorganic sealant 42 (the low-melting-point glass) is approximately 10⁻⁶ g/m²·24 h, and the inorganic sealant 42 is considerably lower in moisture permeability than the organic sealant 41, the penetration of moisture into the area surrounded by the inorganic sealant 42 is suppressed.

The laser beam 61 is incident from the direction of the opposite substrate 30, and is locally emitted to the low-melting-point glass precursor (refer to FIG. 1B) Because the laser beam 61 is not emitted to the organic sealant 41 and the liquid crystal 43, the deterioration (thermal decomposition) in the organic sealant 41 and the liquid crystal 43 due to the local heating by the laser beam 61 is suppressed.

As described above, in the liquid crystal display apparatus according to the first embodiment, the following effects can be obtained.

Because the liquid crystal 43 is enclosed by the inorganic sealant 42 that is considerably small in moisture permeability, the penetration of moisture (external moisture) into the liquid crystal 43 is suppressed. Therefore, the liquid crystal apparatus is provided that prevents the external moisture from causing a change (deterioration) in display performance, and thus is excellent in humidity resistance.

Because the organic sealant 41 is interposed between the inorganic sealant 42 and the liquid crystal 43 and separates the inorganic sealant 42 and the liquid crystal 43 from each other, the inorganic sealant 42 prevents the liquid crystal 43 from being contaminated. Therefore, the liquid crystal display apparatus is provided in which the display irregularity due to the contamination deriving from the inorganic sealant 42 is suppressed and thus the display quality is excellent.

Because the laser beam 61 is emitted to the organic sealant 41 and the liquid crystal 43, the deterioration (thermal decomposition) in the organic sealant 41 and liquid crystal 43 due to the local heating by the laser beam 61 is suppressed.

Because the frame-shaped protective film 15 formed between the inorganic sealant 42 and the metal film suppresses the conduction of the heat of the inorganic sealant 42 locally heated by the laser beam 61 to the metal film is suppressed, the nonconformity is suppressed that is called the crack in the insulating film covering the hillock of the metal film and the metal film.

Because the common electrode 33 and the alignment film 35 are not formed on the edge portion of the opposite substrate 30 through which the laser beam 61 passes, the attenuation of the laser beam 61 due to the absorption, the reflection and others is suppressed.

In addition, the alignment films 16 and 35 are an inorganic alignment film that is made from silicon oxide, but may be an organic alignment film that is made from polyimide. Additionally, the display apparatus according to the first embodiment is a liquid crystal display apparatus in which the liquid crystal as the electro-optic material is enclosed within the area, but may be an organic EL display apparatus in which the organic EL as the electro-optic material is enclosed within the area.

### Second Embodiment

Outline of Display Apparatus

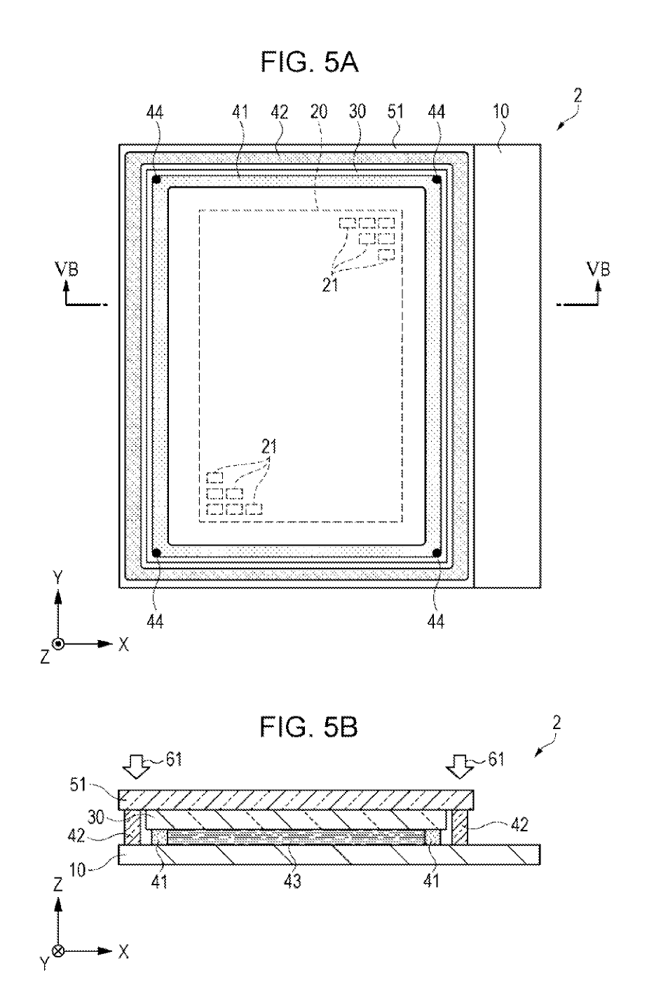

FIGS. 5A and 5B are diagrams, each illustrating a configuration of a display apparatus according to a second embodiment. FIG. 5A is a schematic plan view. FIG. 5B is a schematic cross-sectional view of FIG. 5A that is taken along a line VB-VB. An outline of the display apparatus as an electro-optic apparatus according to the second embodiment is described below, referring to FIGS. 5A and 5B.

Furthermore, in each drawing including FIGS. 5A and 5B, the same constituent parts as those in the first embodiment are given like reference numerals. Additionally, the same descriptions are omitted, and descriptions are provided, with a focus being placed on the differences.

A main difference from the first embodiment is that a new protective substrate 51 is formed on a display apparatus 2 according to the second embodiment. Additionally, there are also differences from the first embodiment in that the display apparatus 2 is a reflection type liquid crystal display apparatus in which an opaque reflection electrode 17 is formed, and in that instead of a protective film 15, a dielectric film 18 is formed in an area to which a laser beam 61 is emitted.

The display apparatus 2 according to the second embodiment is the reflection type liquid crystal display apparatus, and is configured to include an element substrate 10, an opposite substrate 30, a protective substrate 51, an organic sealant 41, an inorganic sealant 42, liquid crystal 43, a conduction material 44 and others. Then, the element substrate 10, the opposite substrate 30, and the protective substrate 51 are laminated in this sequence in the Z-axis (+) direction in the display apparatus 2.

The protective substrate 51 is one example of a “third substrate”, and a quartz glass is used as a suitable example. The protective substrate 51 may be a transparent insulating substrate. For the protective substrate 51, in addition to the quartz glass, a non-alkaline glass, a soda-lime glass, a borosilicate glass, and others can be used.

The protective substrate 51 is arranged in such a manner that the opposite substrate 30 is interposed between and is supported by the protective substrate 51 and the element substrate 10. The protective substrate 51 is greater than the opposite substrate 30, and an edge portion of the protective substrate 51 protrudes much more than the opposite substrate 30, when viewed from above. The protective substrate 51 is formed to cover the opposite substrate 30 between the protective substrate 51 and the element substrate 10. Furthermore, the protective substrate 51 is glued to the opposite substrate 30 by a transparent adhesive agent (an illustration thereof is omitted), and protects the opposite substrate 30 in such a manner that dust does not adhere to the opposite substrate 30.

The element substrate 10 is greater than the opposite substrate 30, an edge portion of the element substrate 10 protrudes much more than an edge portion of opposite substrate 30, when viewed from above. Additionally, one side of the element substrate 10 protrudes from the edge portion of the protective substrate 51, when viewed from above, and the other three sides of the element substrate 10 are in the same position as the edge portion of the protective substrate 51.

The inorganic sealant 42 is a low-melting-point glass that is melted by a local heating of a laser beam 61 and is solidified, and is formed in the shape of a frame, surrounding the opposing substrate 30, to glue the protective substrate 51 and the element substrate 10 together. As a result, the liquid crystal 43, enclosed by the opposite substrate 30, the element substrate 10 and the organic sealant 41, is further enclosed by the protective substrate 51, the element substrate 10 and the inorganic sealant 42, resulting in be enclosed twofold. Additionally, because the inorganic sealant 42 has excellent moisture resistance, the penetration of moisture into the liquid crystal 43 is suppressed.

### Outline of Element Substrate

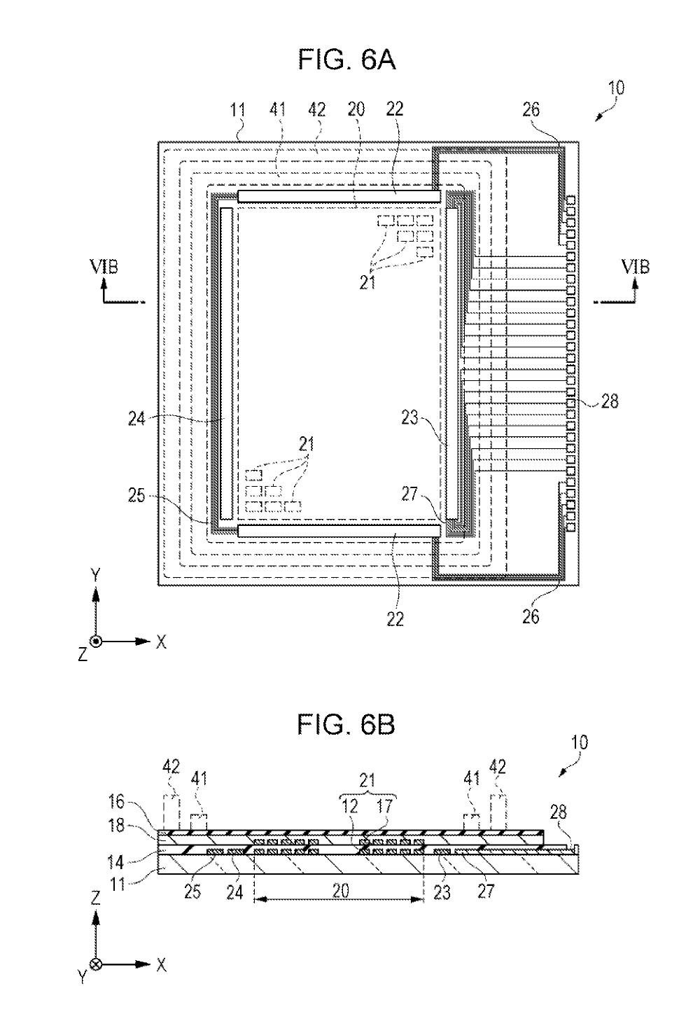

FIGS. 6A and 6B are diagrams, each illustrating a configuration of the element substrate. FIG. 6A is a schematic plan view. FIG. 6B is a schematic cross-sectional view of FIG. 6A that is taken along a line VIB-VIB. In addition, the organic sealant and the inorganic sealant are indicated by broken lines in FIGS. 6A and 6B.

As described above, the element substrate 10 according to the second embodiment is different from that according to the first embodiment in that the opaque reflection electrode 17 is formed and instead of the protective film 15, the dielectric film 18 is formed.

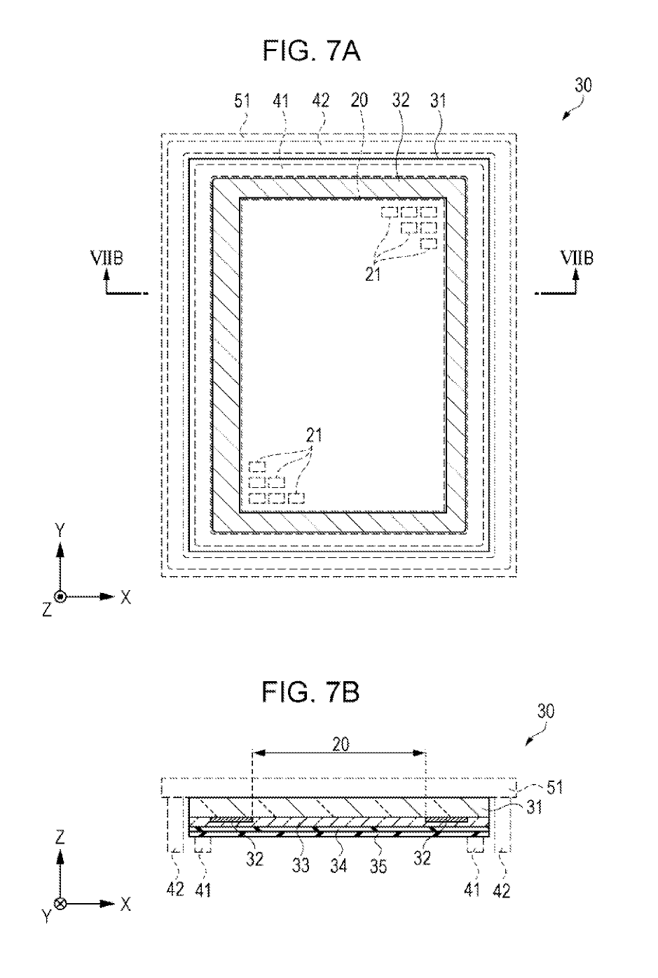

For the reflection electrode 17, aluminum (Al) is used as a suitable example. For the reflection electrode 17, in addition to Al, an alloy a main component of which is Al, silver (Ag), an alloy a main component of which is Ag and others can be used. Al that makes up the reflection electrode 17 of the element substrate 10 and ITO that makes up the common electrode 33 (refer to FIGS. 7A and 7B) of the opposite substrate 30 are different in work function. For this reason, there is a concern that a direct current component based on the work function is applied to the liquid crystal 43, and display nonconformance, such as ghosting (an afterimage) and flicker occurs between the reflection electrode 17 and the common electrode 33.

For the purpose of suppressing (decreasing) the direct current component based on this work function difference, the reflection electrode 17 of the element substrate 10 is covered with the dielectric film 18, and the common electrode 33 of the opposite substrate 30 is covered with the dielectric film 34 (refer to FIGS. 7A and 7B). For the dielectric films 18 and 34, silicon oxide (SiO₂) is used as a suitable example. For the dielectric films 18 and 34, in addition to silicon oxide, silicon nitride, silicon oxynitride, aluminum oxide and others can be used.

In this manner, the dielectric film 18 is an insulating film that is formed between an inter-layer insulating film 14 and an alignment film 16. The dielectric film 18 covers the reflection electrode 17 and extends to a circuit portion and a wiring portion deferred. That is, the dielectric film 18 extends to an area to which the laser beam 61 is emitted. Then, a main body 11 of the element substrate, the wiring portion (the metal film and the insulating film that make up the wiring portion), the inter-layer insulating film 14, the dielectric film 18, the alignment film 16, the inorganic sealant 42 and others are deposited on the area to which the laser beam 61 is emitted, in this sequence toward the Z-axis (+) direction.

The dielectric film 18 is interposed between the inorganic sealant 42 and the metal film (wiring 26 and 27) of the wiring portion and thus heat of the inorganic sealant 42 locally heated by the laser beam 61 is difficult to conduct the metal film of the wiring portion. Because the dielectric film 18 decreases a rise in temperature of the metal film due to the local heating by the laser beam 61, the nonconformance is suppressed that is called the crack in the insulating film covering the hillock of the metal film and the metal film.

### Outline of Opposite Substrate

FIGS. 7A and 7B are diagrams, each illustrating a configuration of the opposite substrate. FIG. 7A is a schematic plan view. FIG. 7B is a schematic cross-sectional view of FIG. 7A which is taken along a line VIIB-VIIB. In addition, in FIGS. 7A and 7B, the organic sealant, the inorganic sealant and the protective substrate are indicated by dashed lines.

The common electrode 33, the dielectric film 34 and the alignment film 35 is formed on the substantially entire surface of the opposite substrate 30. Because the laser beam 61 does not pass through the inside of the opposite substrate 30, even though the common electrode 33, the dielectric film 34 and the alignment film 35 are formed on the substantially entire surface of the opposite substrate, the laser beam 61 is not attenuated.

### Outline of Process of Manufacturing Display Apparatus

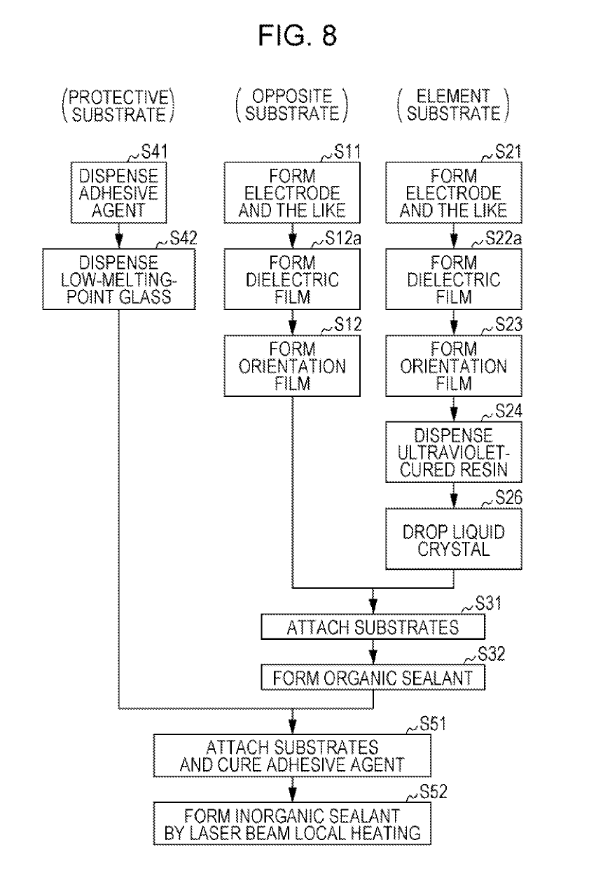

FIG. 8 is a flowchart that illustrates a process of manufacturing the display apparatus according to the second embodiment in process order. An outline of the process of manufacturing the display apparatus according to the second embodiment is described below referring to FIG. 8, with a focus being placed on a difference from the first embodiment.

In Steps S12a and S22a of the process, the dielectric films 18 and 34 are formed on the element substrate 10 and opposite substrate 30. The dielectric films 18 and 34 are silicon oxide, and are formed using a P-CVD technique. In addition, the dielectric film 18 formed on the element substrate 10 is processed into a predetermined shape using well-known techniques such as a photo etching technique.

In Step S41 of the process, an adhesive agent, which glues the protective substrate 51 to the opposite substrate 30, is dropped using a micro pipette. The adhesive agent is a resin of which a main component is an acryl acid resin that is ultraviolet-cured. In addition, the dropped adhesive agent is forcefully expanded in Step S51 of the process described below, and the protective substrate 51 is glued to the opposite substrate 30.

In Step S42 of the process, a low-melting-point glass paste is dispensed onto the element substrate 10 using a dispenser and a frame-shaped low-melting-point glass precursor is formed. In addition, the low-melting-point glass precursor is melted and is solidified in Step S52 of the process described below, and becomes the inorganic sealant 42.

In Step S51 of the process, the protective substrate 51 is attached to a surface of the opposite substrate 30, which is opposite to a surface thereof facing the element substrate 10, and the protective substrate 51 is glued to the opposite substrate 30 by emitting ultraviolet light and solidifying the adhesive agent.

In Step S52 of the process, the inorganic sealant 42 is formed by locally emitting the laser beam 61, and melting and solidifying the low-melting-point glass. The inorganic sealant 42 is formed in the shape of a frame, surrounding the opposite substrate 30.

In addition, in Step S52 of the process, the laser beam 61 is not emitted to the organic sealant 41 and the liquid crystal 43. Therefore, the organic sealant 41 and the liquid crystal 43 do not receive thermal damage without being heated by the laser beam 61.

As described above, in the liquid crystal display apparatus according to the second embodiment, the following effects can be obtained in addition to the effects according to the first embodiment.

The liquid crystal 43, enclosed by the opposite substrate 30, the element substrate 10 and the organic sealant 41, is further enclosed by the protective substrate 51, the element substrate 10 and the inorganic sealant 42, resulting in be enclosed twofold. Additionally, because the inorganic sealant 42 has excellent moisture resistance, an influence of external moisture on the liquid crystal 43 (penetration of water into the liquid crystal 43) is suppressed. Therefore, a change (deterioration) in display quality due to the external moisture is suppressed, and the liquid crystal apparatus, excellent in humidity resistance, is provided.

Since the dielectric film 18 extends to the area to which the laser beam 61 is emitted, the influence of the local heating by the laser beam 61 on the metal film is mitigated (decreased). That is, since the dielectric film 18 decreases the rise in temperature of the metal film due to the local heating by the laser beam 61, the nonconformance is suppressed that is called the crack in the insulating film covering the hillock of the metal film and the metal film.

Additionally, the display apparatus according to the second embodiment is a liquid crystal display apparatus in which the liquid crystal as the electro-optic material is enclosed within the area, but may be an organic EL display apparatus in which the organic EL as the electro-optic material is enclosed within the area.

### Third Embodiment

### Outline of Display Apparatus

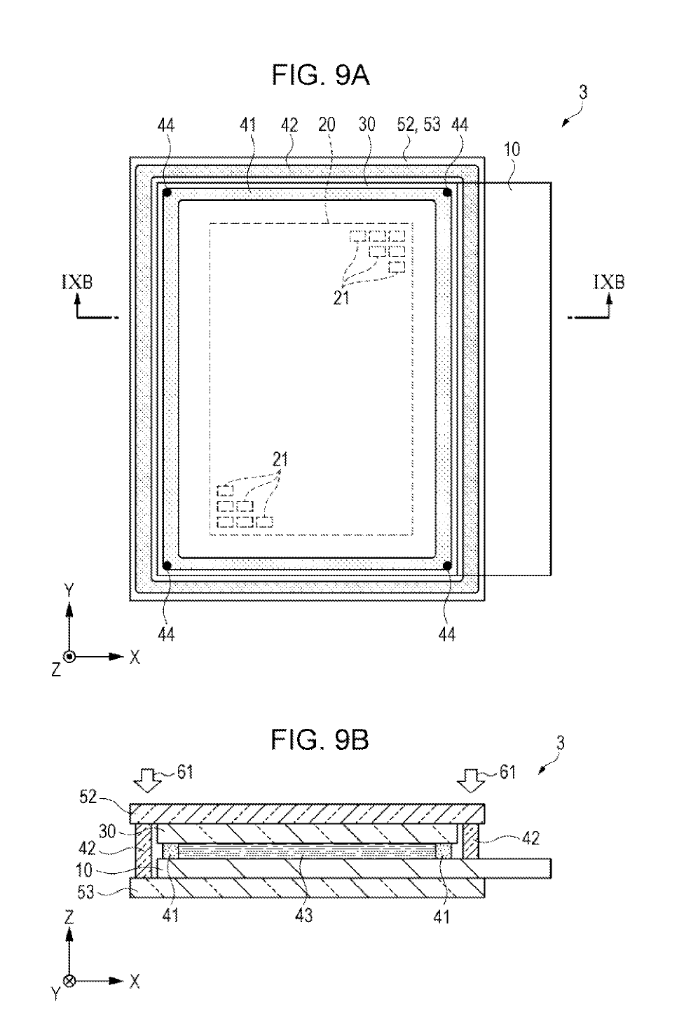

FIGS. 9A and 9B are diagrams, each illustrating a configuration of a display apparatus according to a third embodiment. FIG. 9A is a schematic plan view. FIG. 9B is a schematic cross-sectional view of FIG. 9A that is taken along a line IXB-IXB. An outline of the display apparatus as the electro-optic apparatus according to the third embodiment is described below, referring to FIGS. 9A and 9B.

Furthermore, in each drawing including FIGS. 9A and 9B, the same constituent parts as those in the first embodiment are given like reference numerals. Additionally, the same descriptions are omitted, and descriptions are provided, with a focus being placed on the differences.

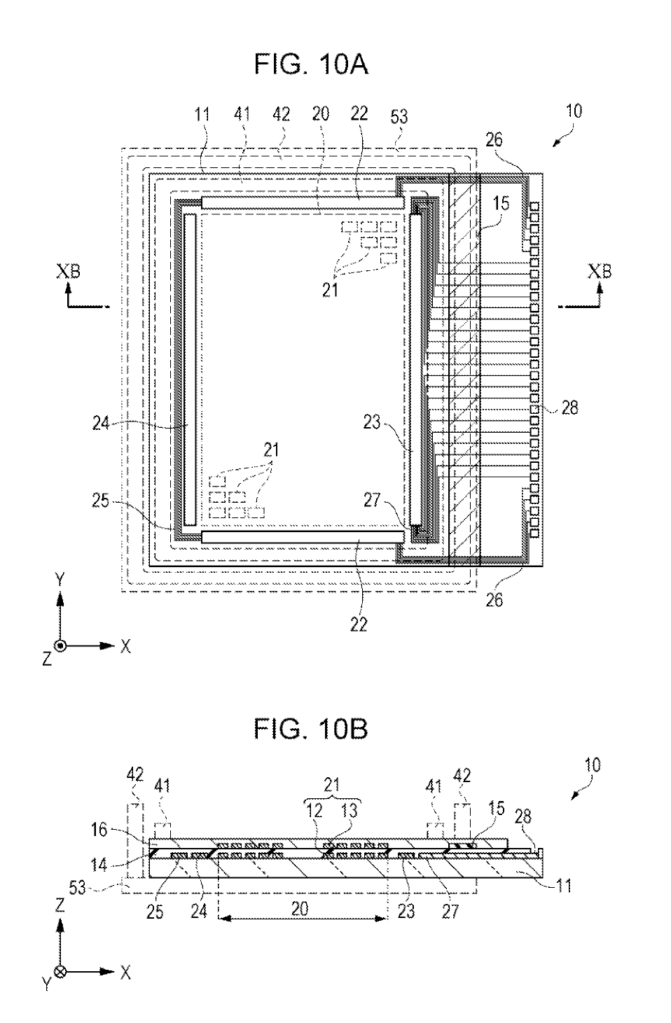

A main difference from the first embodiment is that two protective substrates 52 and 53 are formed on a display apparatus 3 according to the third embodiment. Additionally, a shape of a protective film 15 (refer to FIG. 10A) also is different from that of the protective film according to the first embodiment.

The display apparatus 3 according to the third embodiment is configured to include a second protective substrate 53, an element substrate 10, an opposite substrate 30, a first protective substrate 52, an organic sealant 41, an inorganic sealant 42, liquid crystal 43, a conduction material 44 and others. Then, the second protective substrate 53, the element substrate 10, the opposite substrate 30, and the first protective substrate 52 are laminated in this sequence in the Z-axis (+) direction in the display apparatus 3.

The first protective substrate 52 is one example of a “third substrate”, and a quartz glass is used as a suitable example. The opposite substrate 30 is interposed between and supported by the first protective substrate 52 and the element substrate 10, and the first protective substrate 52 is arranged in such a manner as to cover the opposite substrate 30. The first protective substrate 52 is greater than the opposite substrate 30, and an edge portion of the first protective substrate 52 protrudes much more than an edge portion of the opposite substrate 30, when viewed from above. The first protective substrate 52 protects the opposite substrate 30 in such a manner that dust does not adhere to the opposite substrate 30.

The second protective substrate 53 is one example of a “fourth substrate”, and the quartz glass is used as a suitable example. The second protective substrate 53 is arranged in such a manner that the element substrate 10 is interposed between and is supported by the second protective substrate 53 and the opposite substrate 30.

The second protective substrate 53 and the first protective substrate 52 are in the substantially same dimension. The second protective substrate 53 is greater than the opposite substrate 30, and an edge portion of the second protective substrate 53 protrudes much than the edge portion of the opposite substrate 30, when viewed from above. The second protective substrate 53 protects the element substrate 10 in such a manner that dust does not adhere to the opposite substrate 10.

For the first protective substrate 52 and the second protective substrate 53, the quartz glass is used as a suitable example. The first protective substrate 52 and the second protective substrate 53 may be a transparent insulating substrate. For the first protective substrate 52 and the second protective substrate 53, in addition to the quartz glass, a non-alkaline glass, a soda-lime glass, a borosilicate glass, and others can be used.

One side of the element substrate 10 has a protrusion portion that protrudes much more than an edge of opposite substrate 30, when viewed from above. Multiple terminals 28 are formed on the protrusion portion of the element substrate 10 (refer to FIGS. 10A and 10B). Additionally, in the protrusion portion of the element substrate 10, the edge of the element substrate 10 protrudes much more than the edge of the first protective substrate 52 and the edge of the second protective substrate 53. In areas other than the protrusion portion of the element substrate 10 described above, the edge of the element substrate 10 is in the substantially same position than the edge of the opposite substrate 30, and the edge of the first protective substrate 52 and the edge of the second protective substrate 53 protrude much than the edge of the element substrate 10.

The inorganic sealant 42 is a solid low-melting-point glass that is melted by local heating by a laser beam 61 and is solidified. The inorganic sealant 42 is formed between the first protective substrate 52 and the element substrate 10 in the protrusion portion of the element substrate 10, and is formed between the first protective substrate 52 and the second protective substrate 53 in the area other than the protrusion portion of the element substrate 10. In other words, the inorganic sealant 42 is formed in the shape of a frame form, surrounding the opposite substrate 30 between the first protective substrate 52 and the element substrate 10 or the second protective substrate 53.

In this manner, the inorganic sealant 42 glues the first protective substrate 52 and the element substrate 10 together in the protrusion portion of the element substrate 10 and glues the first protective substrate 52 and the second protective substrate 53 together in the area other than the protrusion portion of the element substrate 10. As a result, the liquid crystal 43 enclosed by the opposite substrate 30, the element substrate 10 and the organic sealant 41, is further enclosed by the first protective substrate 52, the second protective substrate 53, the element substrate 10, and the inorganic sealant 42, resulting in being enclosed twofold. Additionally, because the inorganic sealant 42 has excellent moisture resistance, penetration of moisture into the liquid crystal 43 is suppressed.

### Outline of Element Substrate

FIGS. 10A and 10B are diagrams, each illustrating a configuration of the element substrates. FIG. 10A is a schematic plan view. FIG. 10B is a schematic cross-sectional view of FIG. 10A that is taken along a line XB-XB. In addition, in FIGS. 10A and 10B, the organic sealant, the inorganic sealant and the second protective substrate are indicated by dashed lines.

As described above, in the element substrate 10 according to the third embodiment, a shape of the protective film 15 is different from that according to the first embodiment.

The protective film 15 is formed in the shape of a belt in an area in which the inorganic sealant 42 is formed, and which is positioned to the X-axis (+) side of the element substrate 10. The width (dimension in the X-axis direction) of the protective film 15 is greater than the width of the inorganic sealant 42 when viewed from above, and a side of the protective film 15 along the Y-axis direction protrudes much than a side of the inorganic sealant 42 along the Y-axis direction. Therefore, a configuration is provided in which the protective film 15 is interposed between the inorganic sealant 42 to which the laser beam 61 is emitted, and metal films of wiring 26 and wiring 27. As a result, the protective film 15 makes it difficult for heat of the inorganic sealant 42 locally heated by the laser beam 61 to be conducted to the metal films of the wiring 26 and the wiring 27. Because the protective film 15 decreases a rise in temperature of the metal film due to the local heating by the laser beam 61, the nonconformance is suppressed that is called a crack in the insulating film covering a hillock of the metal film and the metal film.

### Outline of Opposite Substrate

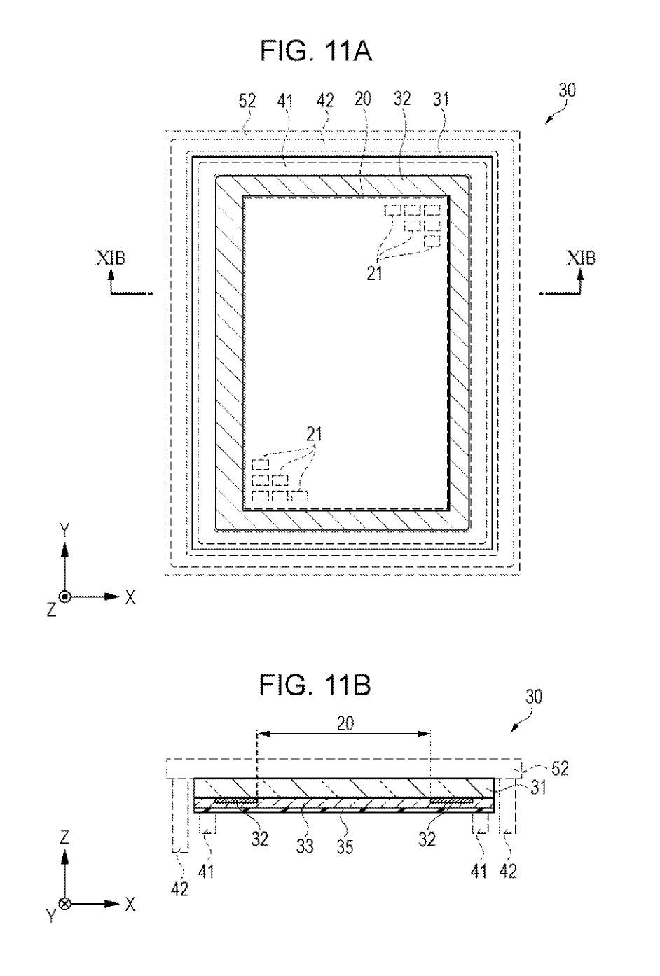

FIGS. 11A and 11B are diagrams, each illustrating a configuration of the opposite substrate. FIG. 11A is a schematic plan view. FIG. 11B is a schematic cross-sectional view of FIG. 11A which is taken along a line XIB-XIB. In addition, the organic sealant, the inorganic sealant and the second protective substrate are indicated by dashed lined in FIGS. 11A and 11B.

In the opposite substrate 30 according to the third embodiment, the common electrode 33 and the alignment film 35 is formed on the almost entire surface of the opposite substrate 30. Because the laser beam 61 does not pass the inside of the opposite substrate 30, even though the common electrode 33, the dielectric film 34 and the alignment film 35 are formed on the substantially entire surface of the opposite substrate, the laser beam 61 is not attenuated.

### Outline of Process of Manufacturing Display Apparatus

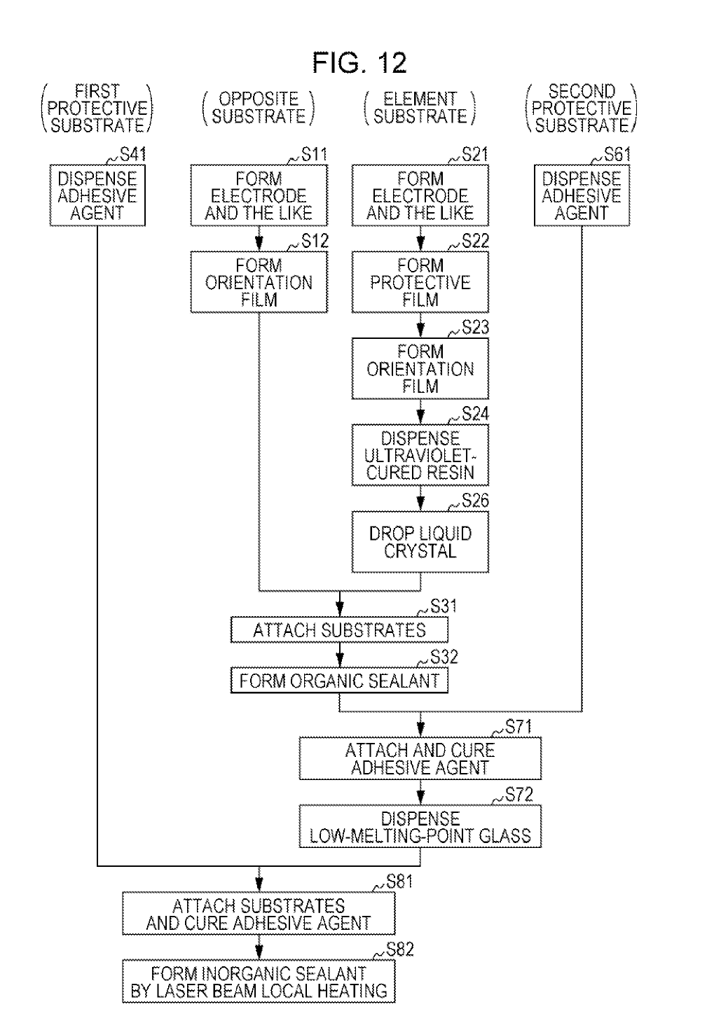

FIG. 12 is a flowchart that illustrates a process of manufacturing the display apparatus according to the third embodiment, in process step order. An outline of the process of manufacturing the display apparatus according to the third embodiment is described below referring to FIG. 12, with a focus being placed on a difference from the first embodiment.

In Step S41 of the process, an adhesive agent to adhere to the opposite substrate 30 is dispensed to be formed on the first protective substrate 52, using the dispenser. The adhesive agent is a resin of which a main component is an acryl acid resin that is ultraviolet-cured.

In Step S61 of the process, the adhesive agent to adhere to the opposite substrate 10 is dispensed to be formed on the second protective substrate 53, using the dispenser. The adhesive agent is the resin of which the main component is an acrylic acid resin that is ultraviolet-cured.

In Step S71 of the process, the second protective substrate 53 is attached to a surface of a substrate that results from gluing the opposite substrate 30 and the element substrate 10 together, the surface being positioned to the side of the opposite substrate 10, and the second protective substrate 53 is glued to the element substrate 10 by emitting the ultraviolet light and solidifying the adhesive agent.

In Step S72 of the process, a low-melting-point glass paste is dispensed onto the element substrate, 10 using the dispenser and a frame-shaped low-melting-point glass precursor is formed. The low-melting-point glass precursor is formed on the element substrate 10 in the protrusion portion of the element substrate 10 described above, and is formed on the second protective substrate 53 in the area other than the protrusion portion of the element substrate 10 (refer to FIG. 10B). The low-melting-point glass precursor is formed in the shape of a frame, surrounding the opposite substrate 30.

In addition, the low-melting-point glass precursor becomes the inorganic sealant 42 in Step S82 of the process described below.

In Step S81 of the process, the first protective substrate 52 is attached to a surface of the substrate that results from gluing the opposite substrate 30, the element substrate 10, the second protective substrate 53 together, the surface being positioned to the side of the opposite substrate 30, and the first protective substrate 52 is glued to the opposite substrate 30 by emitting the ultraviolet light and solidifying the adhesive agent.

In Step S82 of the process, the inorganic sealant 42 is formed by locally emitting the laser beam 61, and melting and solidifying the low-melting-point glass precursor. As a result, the inorganic sealant 42 is formed in the shape of a frame, surrounding the opposite substrate 30, and the penetration of moisture into the liquid crystal 43 is suppressed.

In addition, in Step S82 of the process, the laser beam 61 is not emitted to the organic sealant 41 and the liquid crystal 43. Therefore, the organic sealant 41 and the liquid crystal 43 do not receive thermal damage without being heated by the laser beam 61.

As described above, in the liquid crystal display apparatus according to the third embodiment, the following effects can be obtained in addition to the effects according to the first embodiment.

The liquid crystal 43 enclosed by the opposite substrate 30, the element substrate 10 and the organic sealant 41 is further enclosed by the first protection substrate 52, the second protection substrate 53, the element substrate 10, and the inorganic sealant 42, resulting in being enclosed twofold. Additionally, because the inorganic sealant 42 has excellent moisture resistance, the penetration of external moisture (water) into the liquid crystal 43 is suppressed. Therefore, a change (deterioration) in display quality due to the external moisture is suppressed, and the liquid crystal apparatus, excellent in humidity resistance, is provided.

Because the belt-shaped protective film 15 formed between the inorganic sealant 42 and the metal film makes it difficult for the heat of the inorganic sealant 42 locally heated by the laser beam 61 to be transferred to the metal film, the nonconformity is suppressed that is called the crack in the insulating film covering the hillock of the metal film and the metal film.

Additionally, the display apparatus according to the third embodiment is a liquid crystal display apparatus in which the liquid crystal as the electro-optic material is enclosed within the area, but may be an organic EL display apparatus in which the organic EL as the electro-optic material is enclosed within the area.

In addition, the invention is not limited to the embodiments described above and can add various modifications or improvements to the embodiments described above can be made. Modification Examples are described below.

### Modification Example 1

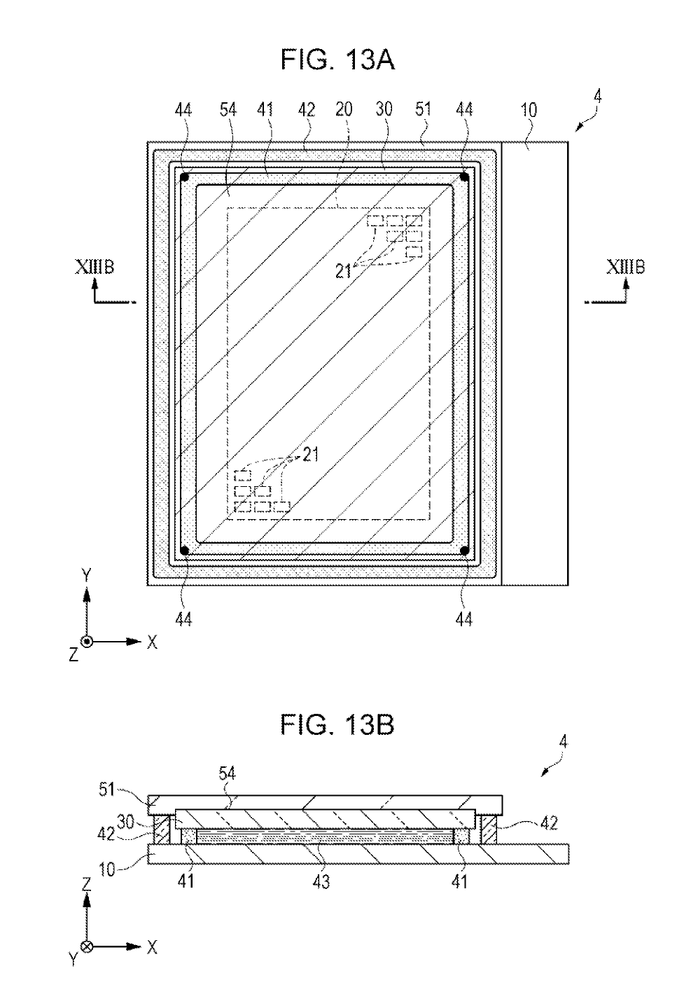

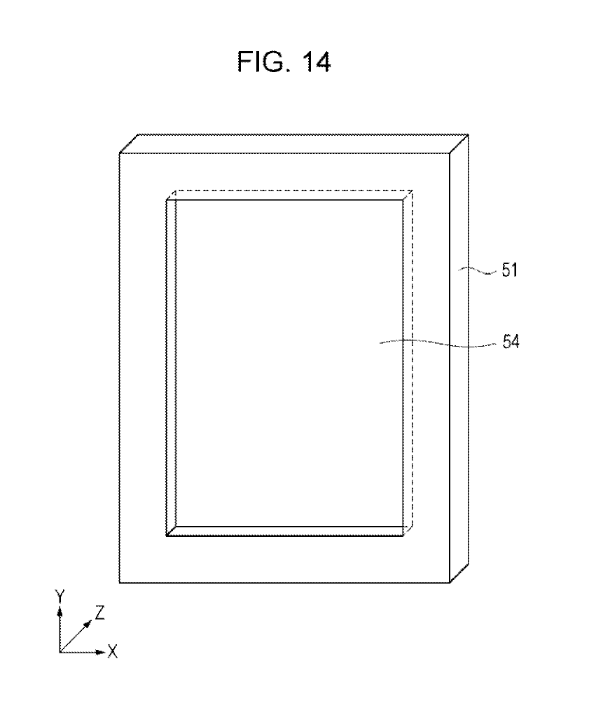

FIGS. 13A and 13B are diagrams, each illustrating a configuration of a display apparatus according to Modification Example 1. FIG. 13A is a schematic plan view. FIG. 13B is a schematic cross-sectional view of FIG. 13A that is taken along a line XIIIB-XIIIB. FIG. 14 is a perspective view of a protective substrate. Modification Example 1 is described below, referring to FIG. 13A to FIG. 14.

A display apparatus 4 according to Modification Example 1 is different from the second embodiment described above, in that a concavity portion 54 is formed on the protective substrate 51, and the other configurations are the same in the second embodiment.

As illustrated in FIGS. 13A and 13B and FIG. 14, the concavity portion 54 is formed on the protective substrate 51. Additionally, a surface of the opposite substrate 30, which is opposite to the element substrate 10, fits into the concavity portion 54 of the protective substrate 51. As a result, an interval (a distance along the Z-axis direction) between the element substrate 10 and the protective substrate 51 is decreased, compared to the second embodiment (refer to FIGS. 5A and 5B). Then, a thickness (a length along the Z-axis direction) of the inorganic sealant 42 formed between the element substrate 10 and the protective substrate 51 is decreased, compared to the second embodiment.

As described above, in the liquid crystal display apparatus according to Modification Example 1, the following effects can be obtained in addition to the effects according to the second embodiment.

The thickness of the inorganic sealant 42, formed between the element substrate 10 and the protective substrate 51, can be decreased by forming the concavity portion 54 in the protective substrate 51 and fitting the opposite substrate 30 into the concavity portion 54. Thus, the time of the local heating by the laser beam 61 (light-emitting time) can be shortened, and the inorganic sealant 42 can be formed in less time. Additionally, distortions that occur during the melting and solidifying process are also reduced, and the cracks in the inorganic sealant 42 and others caused by the resulting distortions are suppressed.

### Modification Example 2

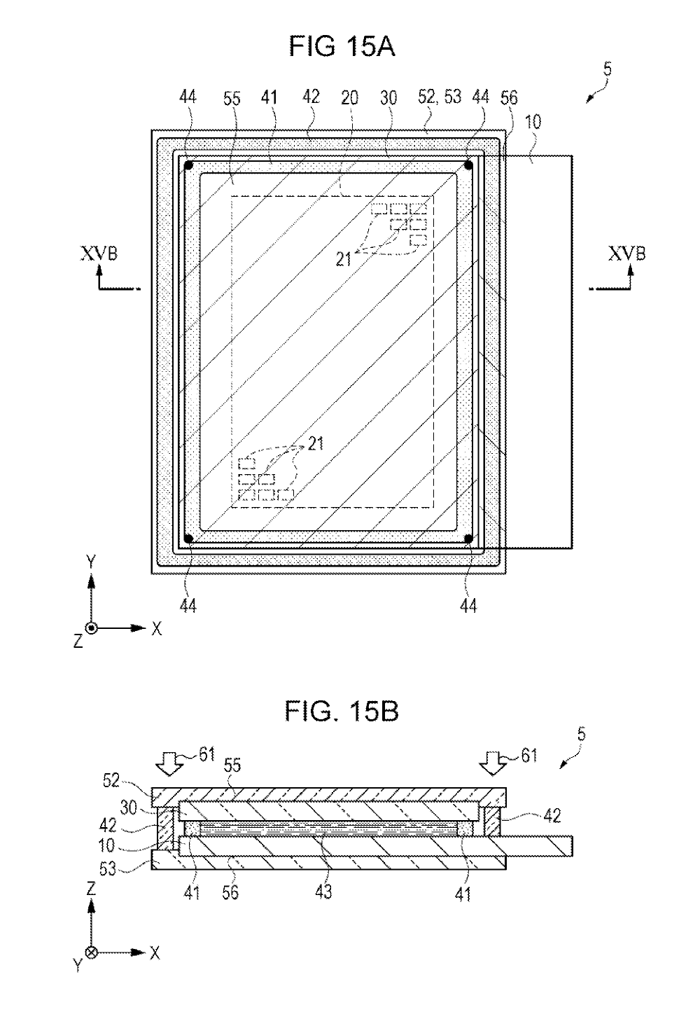

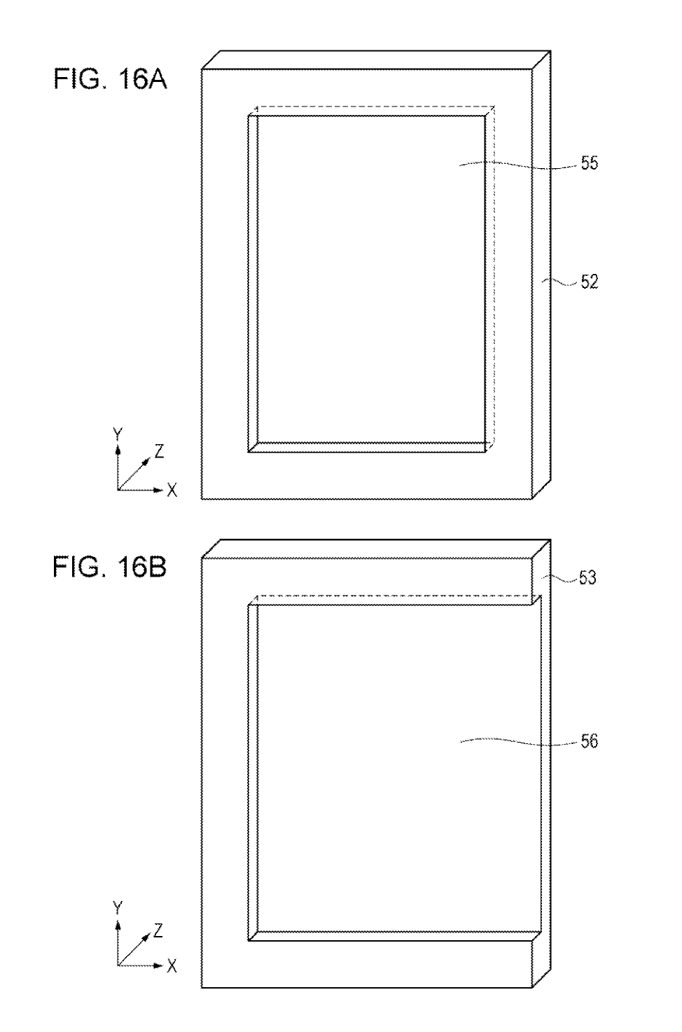

FIGS. 15A and 15B are diagrams, each illustrating a configuration of a display apparatus according to Modification Example 2. FIG. 15A is a schematic plan view. FIG. 15B is a schematic cross-sectional view of FIG. 15A that is taken along a line XVB-XVB. FIG. 16A is a perspective view illustrating a first protective substrate. FIG. 16B is a perspective view illustrating a second protective substrate. Modification Example 2 is described below, referring to FIGS. 15A to 16B.

A display apparatus 5 according to Modification Example 2 is different from the third embodiment described above, in that a concavity portion 55 is formed on the first protective substrate 52 and a concavity portion 56 is formed on the second protective substrate 53, and the other configurations are the same in the third embodiment.

As illustrated in FIGS. 15A to 16B, the concavity portion 55 is formed on the first protective substrate 52, and the concavity portion 56 is formed on the second protective substrate 53. Additionally, a surface of an opposite substrate 30, which is opposite to an element substrate 10, fits into the concavity portion 55 of the first protective substrate 52, and a surface of the element substrate 10, which is opposite to the opposite element substrate 30, fits into the concavity portion 56 of the second protective substrate 53.

An interval (a distance over the Z-axis direction) between the first protective substrate 52 and the second protective substrate 53 and an interval between the first protective substrate 52 and the element substrate 10 are decreased, compared to the third embodiment (refer to FIGS. 9A and 9B). Then, a thickness (a length along the Z-axis direction) of the inorganic sealant 42, formed between the first protective substrate 52 and the second protective substrate 53, and a thickness of the inorganic sealant 42, formed between the first protective substrate 52 and the element substrate 10, are decreased, compared to the third embodiment.

As described above, in the liquid crystal display apparatus according to Modification Example 2, the following effects can be obtained in addition to the effects according to the third embodiment.

The thickness of the inorganic sealant 42, formed between the first protective substrate 52, and the second protective substrate 53, and the thickness of the inorganic sealant 42, formed between the first protective substrate 52 and the element substrate 10, can be decreased by fitting the opposite substrate 30 into the concavity portion 55 formed in the first protective substrate 52 and fitting the element substrate 10 into the concavity portion 56 formed in the second protective substrate 53. Thus, the time of the local heating by the laser beam 61 (light-emitting time) can be shortened, and the inorganic sealant 42 can be formed in less time. Additionally, distortions that occur during the melting and solidifying process are also reduced, and the cracks in the inorganic sealant 42 and others caused by the resulting distortions are suppressed.

In addition, a configuration may be provided in which the concavity portion is formed in either of the first protective substrate 52 and the second protective substrate 53, and either of the element substrate 10 and the opposite substrate 30 fits into the resulting concavity portion. For example, a configuration may be provided in which the concavity portion 56 is formed in the second protective substrate 53, and the element substrate 10 fits into the concavity portion 56.

### Modification Example 3

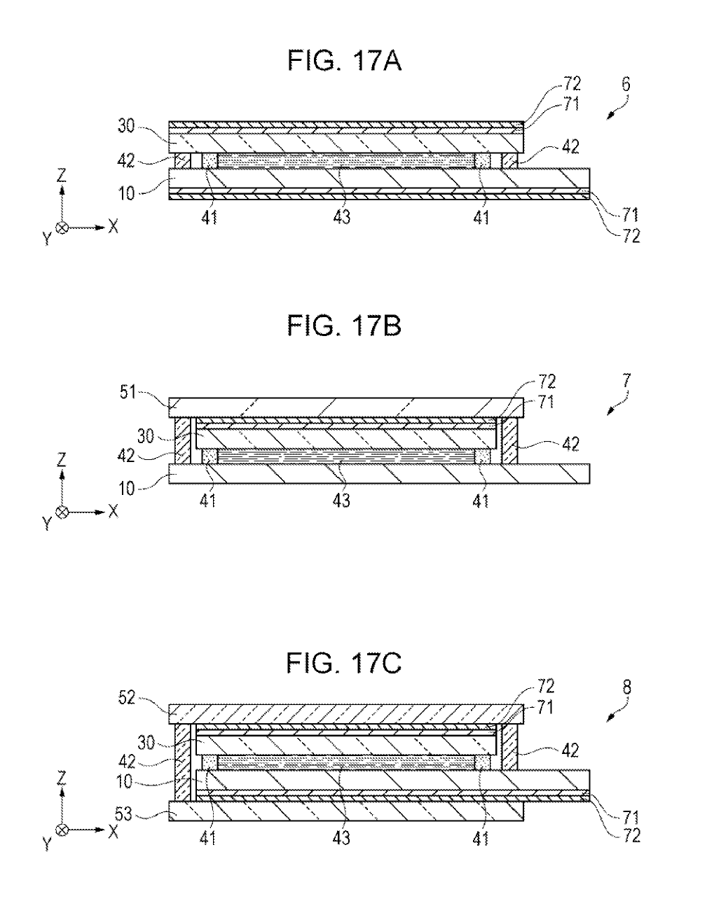

FIGS. 17A to 17C are diagrams, each illustrating a configuration of a display apparatus according to Modification Example 3. FIG. 17A is a diagram illustrating a modification example relating to the display apparatus according to the first embodiment, and corresponds to FIG. 1B. FIG. 17B is a diagram illustrating a modification example relating to the display apparatus according to the second embodiment, and corresponds to FIG. 5B. FIG. 17C is a diagram illustrating a modification example relating to the display apparatus according to the third embodiment, and corresponds to FIG. 9B.

Differences among the embodiments are that a polarization plate and a phase difference substrate are laminated in the display apparatus, and that a color filter is formed on the opposite substrate, and the other configurations are the same among the embodiments.

Descriptions are provided below, referring to FIGS. 17A to 17C with a focus being placed on the differences among the embodiments.

As illustrated in FIG. 17A, a display apparatus 6 is a transparency type color liquid crystal display apparatus that has a phase difference substrate 71 and a polarization plate 72.

The phase difference substrate 71 and the polarization plate 72 are formed on a surface of an opposite substrate 30, which is opposite to an element substrate 10, and on a surface of the element substrate 10, which is opposite to the side of the element substrate 10, facing toward the opposite substrate 30. Furthermore, although the illustration is not omitted, the color filter is formed on the opposite substrate 30.

As illustrated in FIG. 17B, a display apparatus 7 is a reflection type color liquid crystal display apparatus that has a phase difference substrate 71 and a polarization plate 72.

The phase difference substrate 71 and the polarization plate 72 are formed on a surface of an opposite substrate 30, which is opposite to the side of the opposite substrate 30, facing toward an element substrate 10. The phase difference substrate 71 and the polarization plate 72 is enclosed by a protective substrate 51, the element substrate 10 and an inorganic sealant 42, and the penetration of water from the outside is suppressed. Furthermore, although the illustration is not omitted, a color filter is formed on the opposite substrate 30.

As illustrated in FIG. 17C, a display apparatus 8 is a transparency type color liquid crystal display apparatus that has a phase difference substrate 71 and a polarization plate 72.

The phase difference substrate 71 and the polarization plate 72 are formed on a surface of the opposite substrate 30, which is opposite to the element substrate 10 and on a surface of the element substrate 10, which is opposite to the side of the element substrate 10, facing toward the opposite substrate 30. The phase difference substrate 71 and the polarization plate 72, which is formed on the surface of the opposite substrate 30, which is opposite to the side of the opposite substrate 30, facing toward the element substrate 10 are enclosed by the first protective substrate 52, the second protective substrate 53, the element substrate 10 and the inorganic sealant 42, and the penetration of water from the outside is suppressed. Furthermore, although the illustration is not omitted, a color filter is formed on the opposite substrate 30.

Because the influence of external moisture on the liquid crystal 43 (the penetration of water into the liquid crystal 43) is suppressed in the display apparatuses 6, 7, and 8 according to Modification Examples, the display performance is not changed with the external moisture, and thus the liquid crystal display apparatus, excellent in moisture resistance, is provided.

Because the influence of the external moisture is suppressed also with respect to the phase difference substrate 71 and the polarization plate 72 in the display apparatus 7 according to the third modification example, the reflection type color liquid crystal display apparatus is provided in which the change (deterioration) in phase difference performance and polarization performance due to the external moisture is suppressed.

### Modification Example 4

The inorganic sealant 42 in the first embodiment to the third embodiment is a low-melting-point glass that is lower in melting point than the main body 31 of the opposite substrate. The inorganic sealant 42 may be made of metal.

Specifically, the inorganic sealant 42 may be made of metal that is configured from solder, such as a SnPb system alloy, a SnAgCu system alloy, a SnZnBi system alloy, SnCu system alloy, a SnAgInBi system alloy, and the SnZnAl system alloy.

Furthermore, the inorganic sealant 42 may be made of metal that is configured from low-melting-point solder that is a result of adding Bi, Cd, In, Ga, Ag and others to the solder described above and additionally decreasing the melting point.

Additionally, the inorganic sealant 42 may be Al, which is formed using a vacuum film formation method such as evaporation and sputtering, an alloy of which a main component is Al, a metal such as Ti, Ta, Mo, W, and others, or a film formed by depositing these metals.

Additionally, the inorganic sealant 42 may be made of metal, such as Ni, Au, Cu, Cr, Zn, Ag, and others, that is formed using a metal plating technique such as electroplating and electroless plating, or the film formed by depositing these metals.

The metals described above can be melted by the local heating by the laser beam 61 and be solidified, thereby gluing the glass substrates together (sealing by enclosing). Because the metal has excellent moisture resistance, comparable to the moisture resistance to the low-melting-point glass, even though the sealing by enclosing is provided in which the inorganic sealant 42 made of metal is used, the penetration of water into the inside is suppressed.

### Modification Example 5

The protective substrate 51 according to the second embodiment (refer to FIGS. 5A and 5B), and the first protective substrate 52 and the second protective substrate 53 according to the third embodiment (refer to FIGS. 9A and 9B) are configured from the transparent insulating substrate.

The protective substrate 51, the first protective substrate 52, or the second protective substrate 53 may be a touch panel in which an electrode is formed on the insulating substrate described above. For example, the penetration of water into the liquid crystal 43 is suppressed, and thus a touch panel type liquid crystal display apparatus is provided that is excellent in moisture resistance, also by replacing the protection substrate 51 according to the second embodiment with the touch panel.

As the touch panel, a capacitive sensing type touch panel, a resistance sensing type touch panel, an optical sensing type touch panel, an ultrasonic sensing type touch panel, an acoustic pulse recognition type touch panel, an electromagnetic induction type touch panel and others can be used. In addition, because an electrode of the touch panel is influenced by the laser beam 61 (thermally damaged), an electrode in the touch panel is preferably formed in an area to which the laser beam 61 is not emitted.

### Electronic Apparatus

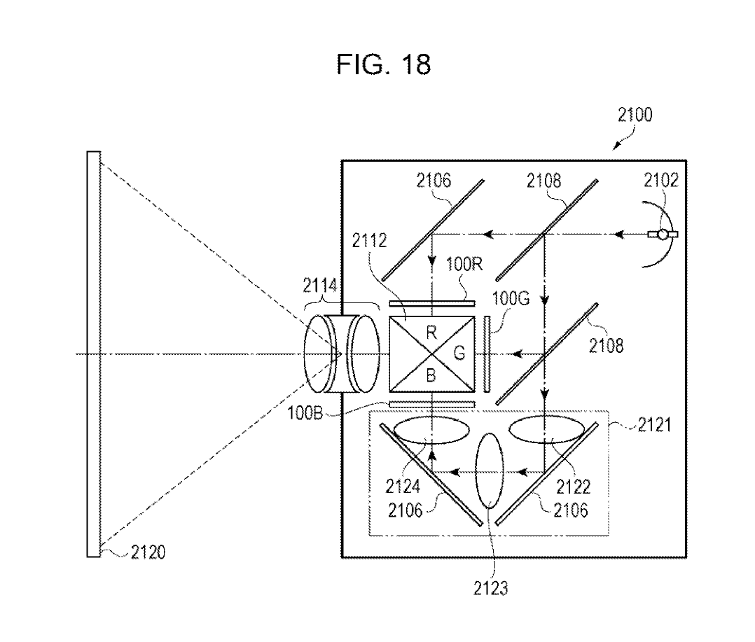

Next, referring to FIG. 18, an example of an electronic apparatus is described, that is equipped with the liquid crystal display apparatus as the electro-optic apparatus according to any one of the first embodiment, the third embodiment, Modification Example 2 and Modification Example 4. FIG. 18 is a plan view illustrating a configuration of a 3-chip project as the electronic apparatus.

In a projector 2100, light emitted from a light source 2102 that is configured from an extra-high pressure mercury lamp is separated into three primary colors, R (red), G (green), and B (blue), by three mirrors 2106 arranged inside the projector 2100, two dichroic mirrors 2108, and then is incident on a light valve 100R, 100G, and 100B that correspond to the primary colors. In addition, because B color light is longer in light path than the other R color light and G color light, in order to prevent loss in the B color light, the B color light is guided through a relay lens system 2121 that is made from an incident lens 2122, a relay lens 2123, and a remission lens 2124.

The display apparatus 1 (the transparency type liquid crystal display apparatus) according to the first embodiment, described above, is applied to configurations of the light valves 100R, 100G and 100B, and each of the light valves 100R, 100G and 100B is driven with image data corresponding to each of the R, G, and B colors, supplied from an external high-order apparatus (an illustration thereof is omitted).

The light modulated by each of the light valves 100R, 100G, and 100B is incident on a dichroic prism 2112, from 3 directions. Then, in the dichroic prism 2112, while the R color light and B color light are refracted by 90 degrees, the G color light goes straight. The light expressing a color image that is synthesized in the dichroic prism 2112 is enlargedly projected by a lens unit 2114, and a full color image is displayed on a screen 2120.

In addition, because while the image that has passed through the light valves 100R and 100B is reflected by dichroic prism 2112 and then is projected, the image that has passed the light valve 100G is projected, as it is, a setting is provided in such a manner that the image formed by the light valve 100R and the light valve 100B and the image formed by the light valve 100G is in a left-right reversal relationship.

Because the display apparatus 1 according to the first embodiment, described above, as the light valves 100R, 100G and 100B, is applied to the projector 2100 as the electronic apparatus according to the embodiments, the projector is provided that is excellent in moisture resistance, and the nonconformity such as display irregularity is suppressed, and thus has excellent display quality.

Furthermore, a projector using the reflection type liquid crystal display apparatus, a rear projection type television, a direct view type television, a mobile phone, a portable audio apparatus, a personal computer, a monitor of a video camera, a car navigation apparatus, a pager, a personal digital assistance, an electronic calculator, a workstation, a television phone, a POS terminal, a digital still camera and others are numerated as the electronic apparatus, in addition to the projector that uses the transparency type liquid crystal display apparatus, described above referring to FIG. 18. Then, the display apparatus according to the invention can be applied to the electronic apparatuses described above.

This application claims priority from Japanese Patent Application No. 2012-090843 filed in the Japanese Patent Office on Apr. 12, 2012, the entire disclosure of which is hereby incorporated by reference in its entirely.

What is claimed is:

1. An electro-optic apparatus comprising:
a first substrate;
a second substrate that is arranged opposite to the first substrate;
an organic sealant that seals the first substrate and the second substrate and a main component of which is an organic material;
an electro-optic material that is enclosed within an area surrounded by the organic sealant; and
an inorganic sealant that seals the first substrate and the second substrate, and that is formed between an edge of the first substrate and the organic sealant, surrounding the organic sealant.

2. An electro-optic apparatus comprising:
a first substrate;
a second substrate that is arranged opposite to the first substrate, and an edge of which protrudes much than an edge of the first substrate;
an organic sealant that seals the first substrate and the second substrate and a main component of which is an organic material;
an electro-optic material that is enclosed within an area surrounded by the organic sealant;
a third substrate that is arranged in such a manner that the first substrate is interposed between and is supported by the third substrate and the second substrate, and an edge of which protrudes much than an edge of the first substrate; and
an inorganic sealant that seals the second substrate and the third substrate, and that is formed between the edge of the first substrate and an edge of the second substrate, surrounding the organic sealant.

3. An electro-optic apparatus comprising:
a first substrate;
a second substrate that is arranged opposite to the first substrate, and that has a protrusion portion which protrudes much than an edge of the first substrate when viewed from above and on which a plurality of terminals are formed;
an organic sealant that seals the first substrate and the second substrate and a main component of which is an organic material;
an electro-optic material that is enclosed within an area surrounded by the organic sealant;
a third substrate that is arranged in such a manner that the first substrate is interposed between and is supported by the third substrate and the second substrate, and an edge of which protrudes much than an edge of the first substrate when viewed from above;
a fourth substrate that is arranged in such a manner that the second substrate is interposed between and is supported by the fourth substrate and the first substrate, and an edge of which protrudes much than the edge of the first substrate when viewed from above; and
an inorganic sealant that is formed in the shape of a frame in such a manner as to surround the organic sealant, when viewed from above,
wherein the edge of the third substrate is formed between the edge of the first substrate and the plurality of terminals in the protrusion portion of the second substrate, and the edges of the third substrate and the fourth substrate protrude much than the edge of the second substrate in areas other than the protrusion portions of the second substrate, and
wherein the inorganic sealant that seals a portion of the third substrate, which overlaps the protrusion portion of the second substrate, when viewed from above, and the protrusion portion of the second substrate, and seals the third substrate and the fourth substrate, between the edge of the third substrate and the edge of the second substrate, in the areas other than the protrusion portion of the second substrate.

4. The electro-optic apparatus according to claim 1,
wherein the second substrate includes a metal film,
wherein the inorganic sealant on the second substrate is locally heated by a laser beam that is incident on the second substrate from the first substrate, and
wherein a protective film is formed between the metal film and the inorganic sealant, on the second substrate, to mitigate an influence of the local heating on the metal film.

5. The electro-optic apparatus according to claim 4,
wherein a material with which the protective film is formed is any one of silicon oxide, silicon nitride and silicon oxynitride.

6. The electro-optic apparatus according to claim 1,
wherein a material with which the inorganic sealant is formed is any one of a metal and a low-melting-point glass that is lower in melting point than the first substrate.

7. The electro-optic apparatus according to claim 2,
wherein a concavity portion is formed on the third substrate, and the first substrate fits into the concavity portion.

8. The electro-optic apparatus according to claim 3,
wherein the concavity portion is formed on at least one of the third substrate and the fourth substrate, and at least one of the first substrate and the second substrate fits into the concavity portion.

9. The electro-optic apparatus according to claim 2,
wherein a transparent opposite electrode is formed on the first substrate, a reflection electrode is formed on the second substrate, and the reflection electrode is covered with a dielectric film that extends to an area on which the inorganic sealant is formed.

10. The electro-optic apparatus according to claim 9,
wherein a material with which the dielectric film is formed is any one of silicon oxide, silicon nitride, silicon oxynitride and aluminum oxide.

11. The electro-optic apparatus according to claim 1, further comprising:
an inorganic alignment film that is oblique-deposited.

12. An electronic apparatus comprising:
the electro-optic apparatus according to claim 1.
